(19) United States
(12) Patent Application Publication
(10) Pub. No.: US 2006/0041595 A1
(43) Pub. Date: Feb. 23, 2006

(54) Storage network migration method, management device, management program and storage network system

(75) Inventors: Yuichi Taguchi, Tokyo (JP); Fumi Miyazaki, Tokyo (JP); Yasunori Kaneda, Tokyo (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi, Ltd., Tokyo (JP)

(21) Appl. No.: 10/969,437

(22) Filed: Oct. 19, 2004

(30) Foreign Application Priority Data
Aug. 19, 2004 (JP) 2004-239947

(51) Int. Cl. G06F 12/00

(52) U.S. Cl. 707/200

(57) ABSTRACT

A method and means for reducing the workload on a system administrator are provided for use in the migration of a storage device or a storage network. A storage network management device is connected to all storage devices and host computers related to the migration via a management network. This configuration allows the storage network management device to acquire configuration information on the network and attribute information on the data extents of the storage devices from the storage devices and the host computers related to the migration. Therefore, the storage network management device can control the migration of configuration management information across different networks by referring to the acquired information.

### INCORPORATION BY REFERENCE

The present application claims priority from Japanese application JP2004-239947 filed on Aug. 19, 2004, the content of which is hereby incorporated by reference into this application.

### BACKGROUND OF THE INVENTION

The present invention relates to a method for migrating network management information among a plurality of storage networks that use different management methods and to a device, a program, and a storage network system for managing the migration.

Recently, the amount of information managed by an electronic computer (hereinafter called a computer) is increased significantly in many fields and the need arises for the high reliability of the information and a storage device in which the information is stored. As a large-capacity, high-reliability storage device that satisfies this need, many installations use Redundant Arrays of Inexpensive Disks (RAID) in which many disk units are redundantly configured as an array. In addition, as computer applications become more diversified, a variety of information is created and managed and, in many cases, the information is shared among a plurality of computers. This leads to the concept of a storage network (sometimes called Storage Area Network (SAN)) where a plurality of storage devices such as RAIDs are connected via a network for sharing among a plurality of computers. Today, a storage network is widely used in many fields, for example, in financial systems where highly reliable management is required.

Today, an optical fibre cable is used in many storage networks. To this optical fibre cable, storage devices and computers are connected via the interface specifications called Fibre Channel (sometimes abbreviated FC). The interface specifications defined by Fibre Channel include not only electrical and physical specifications but also layers 1-3 and a part of layer 4 of the Open System Interconnection (OSI) reference model. Although data is transferred reliably at a high data rate (2G bps) in a Fibre Channel storage network, the overall cost of the system increases.

On the other hand, iSCSI is proposed recently as a protocol for sending and receiving Small Computer System Interface (SCSI) commands via an Internet Protocol (IP) network, and the standardization work is carried out by the Internet Engineering Task Force (IETF). The iSCSI protocol allows a user not only to build an IP network with optical fibres but also to use an existing Ethernet (registered trademark), enabling the user to build a storage network at a low cost.

Under the situation described above, the system administrator of a storage network system is sometimes required to improve the system according to the data amount, the data transfer rate, the reliability, and the operation cost requested by the applications so that the system can be optimized. In this case, it is necessary to move data from an existing storage device to a new storage device and to set the logical configuration information and access permission information on the new storage device as well as the storage network configuration information in the new storage network. The migration to a new storage device or to a new storage network places a heavy load on the system administrator. Recently another problem with the migration is that there are storage networks using different data transfer methods such as a Fibre Channel storage network (hereinafter abbreviated an FC network) and an iSCSI storage network (hereinafter abbreviated an iSCSI network). The migration of a storage device between different types of storage networks further increases the load on the system administrator.

WO 97/09676 discloses a technology for migrating a storage system from a first storage system to a second storage system. According to the storage system migration technology disclosed in that document, a storage system can be migrated while running the computer applications that use the storage system.

However, WO 97/09676 does not disclose a technology for reducing the workload on the system administrator during storage system migration. Nor does it disclose a technology for storage system migration between storage networks using different protocols, for example, from the FC network to the iSCSI network described above. Actually, however, an attempt to migrate a storage device between storage networks using different data transfer methods places a heavy workload on the system administrator; for example, the system administrator must migrate or newly set the logical configuration information and the access permission information on the storage device as well as the configuration information on the storage network. Therefore, it is an object of the present invention to provide a migration method, a management device, and a management program that can reduce the workload on the system administrator when a storage device or a storage network is migrated.

The storage system migration between storage networks using different protocols is cumbersome because the method for identifying a computer or a storage device differs from protocol to protocol. For example, a computer and a storage device on an FC network are identified by a name (called a World Wide Port Number (WWPN)) uniquely assigned to a network port connected to the FC network, while a computer and a storage device on an iSCSI network are identified by a name (called an iSCSI name) assigned to the computer or the storage device itself (called a node). Therefore, the system administrator must establish the correspondence between WWPNs and iSCSI names as well as the port configuration. After establishing this correspondence, the system administrator must migrate the information such as the access permission information. It is another object of the present invention to provide a management device and a migration program that control the migration of a storage device or a storage network between storage networks that use different protocols and a storage network system for the migration.

### SUMMARY OF THE INVENTION

To solve at least one of the problems described above, one embodiment of the present invention is a storage network migration method for use in a storage network system comprising at least one storage device, at least one host computer, a first storage network and a second storage network connecting the storage device and the host computer, a storage network management device, and a management network via which the storage network management device is connected to the storage device and the host computer, wherein a first data extent included in the storage device and connected to the first storage network is migrated to a second data extent included in the storage device and connected to the second storage network, the storage network migration method comprising a first step by the storage network management device which acquires information on a network interface of the storage network, connected to the storage device or the host computer, from the storage device and the host computer via the management network and stores the acquired information as network configuration information; a second step, by the storage device including the first data extent, which receives information identifying the first data extent and the second data extent, adds and stores the received information in storage configuration information thereof, and sends the stored information and attribute information stored in the first data extent to the storage network management device; a third step by the storage network management device which converts the attribute information stored in the first data extent to attribute information to be stored in the second data extent based on the storage network configuration information stored in the first step and the information sent from the storage device in the second step; a fourth step by the storage network management device which sends the attribute information, converted in the third step, to the storage device including the second data extent; and a fifth step, by the storage device including the second data extent, which adds and stores the attribute information sent from the storage network management device in the fourth step to storage configuration thereof as attribute information in the second data extent.

In accordance with the embodiment described above, the storage network management device and the management network are provided wherein the storage network management device is connected to the storage devices and the host computers, related to a migration, via the management network. This configuration allows the storage network management device to acquire configuration information on the storage network, to which the storage devices and host computers related to the migration are connected, from those devices and computers without human intervention. Therefore, once the system administrator enters information associating the data extents on the source storage device with those on the destination storage device, the migration between the storage devices or storage networks is executed under control of the storage network management device. That is, the workload on the system administrator is reduced significantly.

This method reduces the workload on the system administrator when a storage device is migrated between a plurality of storage networks or a storage network that use different data transfer protocols is migrated.

Other objects, features and advantages of the invention will become apparent from the following description of the embodiments of the invention taken in conjunction with the accompanying drawings.

### BRIEF DESCRIPTION OF THE DRAWINGS

FIG. 1 is a diagram schematically showing the migration of a storage device and a storage network in a first embodiment of the present invention.

FIG. 2 is a diagram schematically showing the migration of a storage network in the same storage device in the first embodiment of the present invention.

FIG. 3 is a diagram showing an example of the general configuration of a storage network system to which a storage network management device in the first embodiment of the embodiment is applied.

FIG. 4 is a diagram showing an example of the configuration of a storage device in the first embodiment of the present invention.

FIG. 5 is a diagram showing an example of the configuration of a host computer in the first embodiment of the present invention.

FIG. 6 is a diagram showing an example of the configuration of the storage network management device in the first embodiment of the present invention.

FIG. 7A is a diagram showing an example of storage configuration information stored in storage device S1 in the first embodiment of the present invention.

FIG. 7B is a diagram showing an example of storage configuration information stored in storage device S2 in the first embodiment of the present invention.

FIG. 8 is a diagram showing an example of storage network configuration information stored in the storage network management device in the first embodiment of the present invention.

FIG. 9 is a flowchart showing the procedure used by the storage network configuration management program of the storage network management device for creating storage network configuration information in the first embodiment of the present invention.

FIG. 10 is a flowchart showing the detailed procedure for acquiring Fibre Channel configuration information in step S14 in FIG. 9.

FIG. 11 is a flowchart showing the detailed procedure for acquiring iSCSI configuration information shown in step S15 in FIG. 9.

FIG. 12 is a flowchart showing the general procedure for operating a storage device.

FIG. 13 is a flowchart showing the processing procedure for migrating data among a plurality of storage extents in the first embodiment of the present invention.

FIG. 14 is a flowchart showing the procedure used by the storage network management device for acquiring storage management information from the source storage device when connectable host computer identification information is registered in the destination storage extent.

FIG. 15 is a flowchart showing the procedure for converting host computer identification information when connectable host computer identification information is registered in the destination storage extent.

FIG. 16 is a flowchart showing the procedure used by the destination storage device for registering connectable host computer identification information in the destination storage extent based on information sent from the storage network management device when the connectable host computer identification information is registered in the destination storage extent.

FIG. 17 is a flowchart showing the detailed processing procedure for converting host computer identification information for FC to host computer identification information for iSCSI in step S75 in FIG. 15.

FIG. 18 is a flowchart showing the detailed processing procedure for selecting additional connectable host computers in step S81 in FIG. 16.

FIG. 19 is a diagram schematically showing the migration of a storage network in a second embodiment of the present invention.

FIG. 20 is the first half of a flowchart showing the processing procedure for migrating a connection to a storage extent to a host computer that is different from the host computer currently in operation in the second embodiment of the present invention.

FIG. 21 is the second half of a flowchart showing the processing procedure for migrating a connection to a storage extent to a host computer that is different from the host computer currently in operation in the second embodiment of the present invention.

FIG. 22 is a flowchart showing the detailed procedure, executed in step S114 in FIG. 20, for acquiring a data I/O interface connected to a storage extent.

FIG. 23 is a diagram showing the configuration of a host computer when the host computer works also as the storage network management device in the first or second embodiment of the present invention.

FIG. 24 is a diagram showing the configuration of a storage network system where a storage management device is further provided in the storage network system in the first or second embodiment of the present invention.

FIG. 25 is a diagram showing an example of the configuration of the storage management device in a second modification of the embodiments.

### DETAILED DESCRIPTION OF THE EMBODIMENTS

### First Embodiment

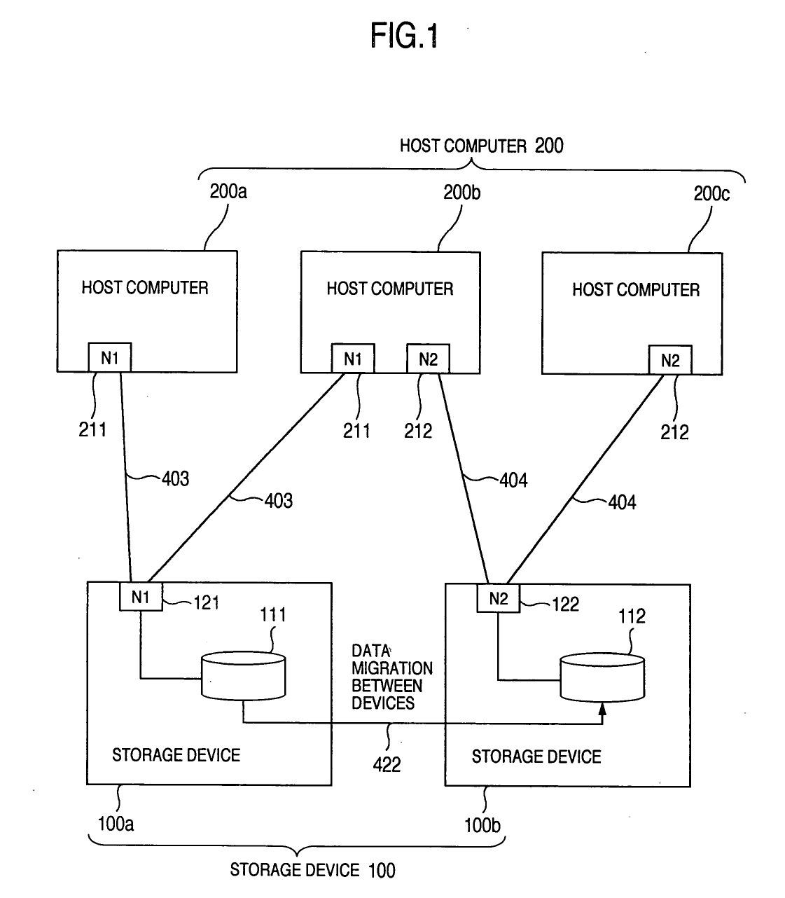

A first embodiment of the present invention will be described in detail below with reference to FIGS. 1-18.

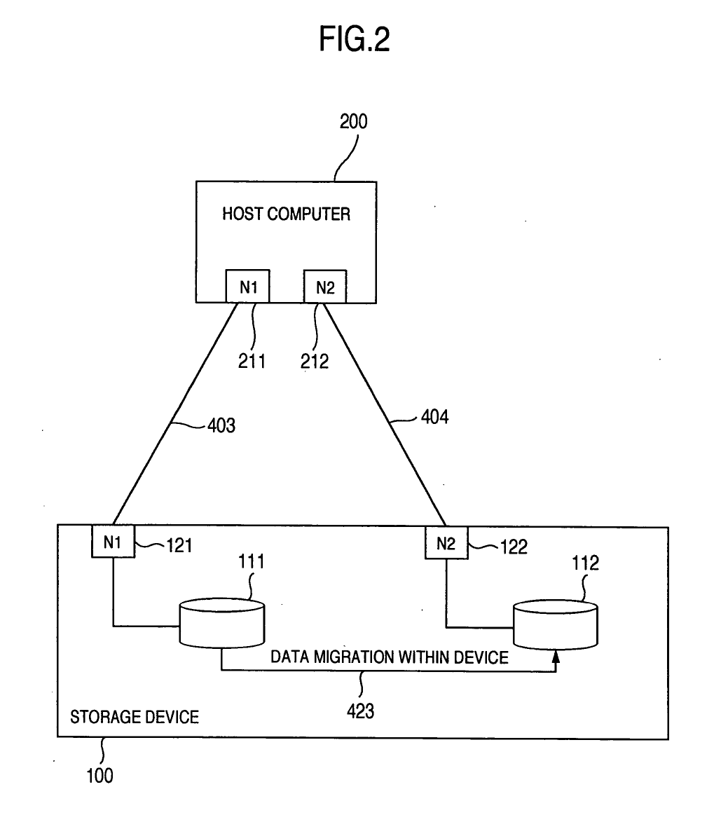

First, the migration of a storage device and a storage network will be described with reference to FIG. 1 and FIG. 2. FIG. 1 is a diagram schematically showing the migration of a storage device and a storage network. FIG. 2 is a diagram schematically showing the migration of a storage network in the same storage device.

Referring to FIG. 1, a data extent 111 of a storage device 100a is connected to a data I/O interface (N1) 121, and host computers 200a and 200b are connected to the storage device 100a via a data I/O interface (N1) 211 and a communication path 403. On the other hand, a data extent 112 of a storage device 100b is connected to a data I/O interface (N2) 122, and host computers 200b and 200c are connected to the storage device 100b via a data I/O interface (N2) 212 and a communication path 404. In such a configuration, the data in the data extent 111 of the storage device 100a is moved to the data extent 112 of the storage device 100b. As the data is moved in this way, the data is migrated from the storage network configured by the communication path 403 to the storage network configured by the communication path 404.

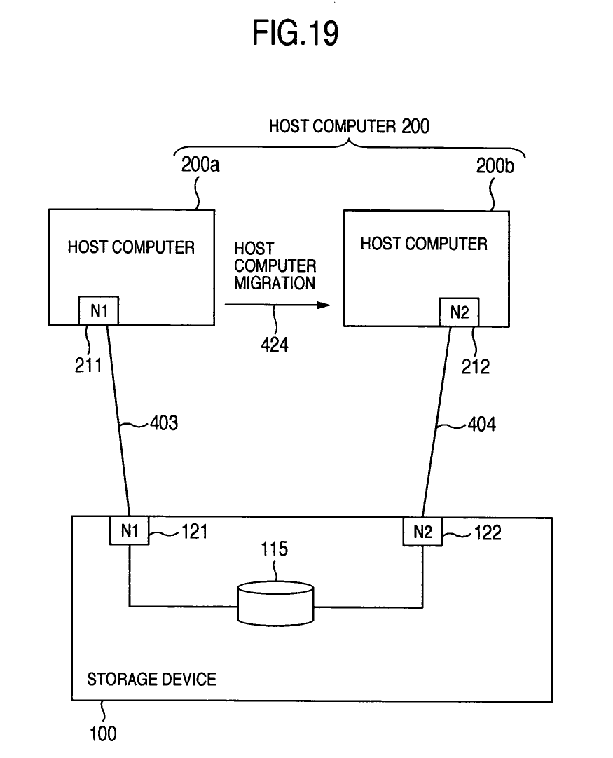

Note that the communication path 403 and the communication path 404 are a logical communication path indicating a logical connection, not a physical connection. That is, the communication path 403 and the communication path 404 are a connection via a storage network. This also applies to the diagrams in FIG. 2 and FIG. 19. In this specification, a communication path refers to a logical communication path.

When data is migrated in this way from the data extent 111 of one storage device to the data extent 112 of another storage device, not only the data but also the network configuration information must be migrated. The network configuration information can be easily migrated from the before-migration storage network to the after-migration storage network if the same network protocol is used. However, if the network protocol used in the before-migration storage network is different from that used in the after-migration storage network, the network configuration information cannot be migrated easily. This is because the method for identifying a storage device and a computer depends on the network protocol.

For example, in FIG. 1, assume that the before-migration storage network configured by the communication path 403 is an FC network and that the after-migration storage network configured by the communication path 404 is an iSCSI network. In this case, in the before-migration storage device 100a, the host computers 200a and 200b are managed by the identification information such as WWPN's in the FC network; in the after-migration storage device 100b, the host computers 200b and 200c are managed by the iSCSI names in the iSCSI network. Therefore, before a data extent is migrated, it is necessary to establish the correspondence between the before-migration network configuration information on the FC network and the after-migration network configuration information on the iSCSI network. In this case, it is important to clearly establish the correspondence between WWPN's and iSCSI names. Based on this correspondence relation, the access control information on the host computers 200 is set in the storage device 100b after the migration.

Sometimes, a data extent is also moved from one location to another in the same storage device as shown in FIG. 2. In FIG. 2, however, the communication path connecting the storage device 100 and the host computer 200 is changed from the communication path 403 to the communication path 404. Each of the communication paths 403 and 404 forms a storage network. Therefore, if the network protocol differs between the storage networks, the correspondence of the network configuration information must be established between the before-migration storage network and the after-migration storage network as in FIG. 1, and the access control information must be set accordingly.

In this embodiment, an example of a storage network management device that allows the user to easily set the access control information and an example of a migration method using the storage network management device will be shown, based on the network configuration information on the before-migration storage network and the network configuration information on the after-migration storage network.

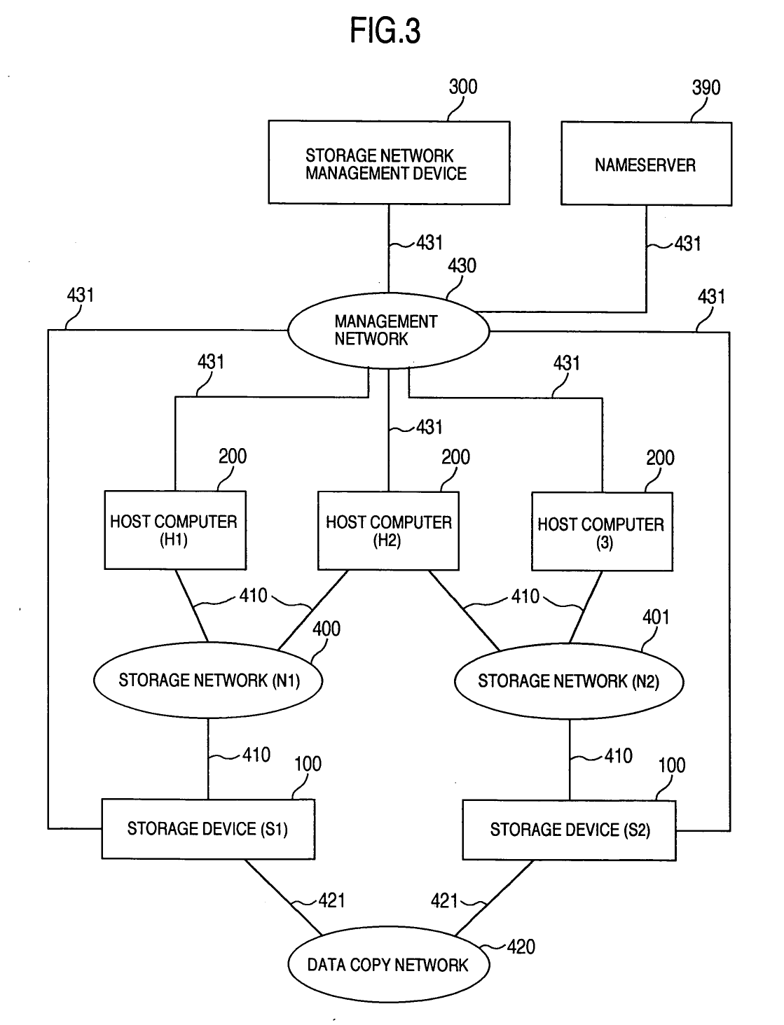

FIG. 3 is a diagram showing an example of the general configuration of a storage network system to which the storage network management device in this embodiment is applied. Referring to FIG. 3, the host computers 200 are connected to the storage devices 100 via storage networks 400 and 401. Note that the storage networks 400 and 401 are networks each comprising one or more connection devices compatible with Fibre Channel or Ethernet (registered trademark).

The storage devices 100 and the storage networks 400 and 401, and the host computers 200 and the storage networks 400 and 401, are connected by data I/O network paths 410. One storage device 100 is connected to another storage device 100 via a data copy network 420. As with the storage network 400, the data copy network 420 and a data copy network path 421 comprise network connection devices compatible with Fibre Channel or Ethernet (registered trademark).

Note that the data copy network 420 need not be an independent network but may share a network with the storage networks 400 and 401.

A storage network management device 300 is provided in the storage network system, configured as described above, for managing the migration between the storage devices 100. The storage network management device 300 is connected via a management network 430 to all storage devices 100 and all host computers 200 involved in the migration. As with the storage network 400, the management network 430 and management network paths 431 comprise network connection devices compatible with Fibre Channel or Ethernet (registered trademark).

Note that the management network 430 need not be an independent network but may share a network with the storage network 400. A nameserver 390, for example, a name server used for resolving iSCSI names when the storage network is an iSCSI network, is connected to the management network 430. The nameserver 390 may also be connected to the management network 430 via another IP network.

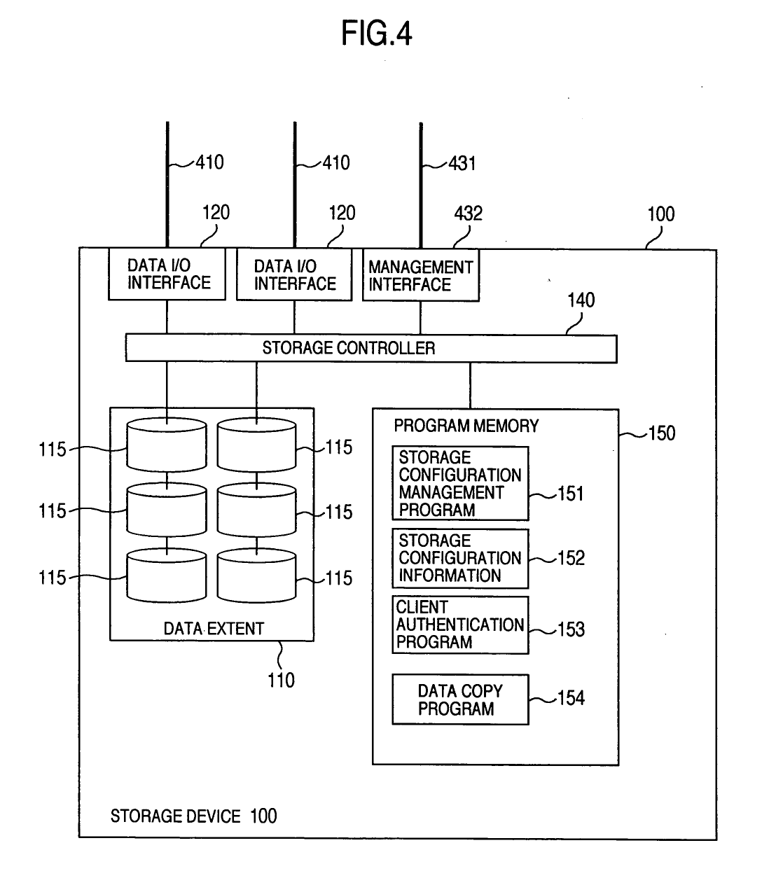

FIG. 4 is a diagram showing an example of the configuration of a storage device in this embodiment. The storage device 100 comprises data I/O interfaces 120, a management interface 432, a storage controller 140, a program memory 150, and a data extent 110.

In FIG. 4, the data I/O interface 120 is connected to the storage network 400 via the data I/O network path 410 to send and receive data to and from the data extent 110. The management interface 432 is connected to the management network 430 via the management network path 431 to send and receive management information related to the storage device 100 and the storage network 400. The data I/O interfaces 120 and the management interface 432 comprise network input/output devices compatible with Fibre Channel or Ethernet (registered trademark). Any number of data I/O interfaces 120 can be used as long as they can be installed. Note that the management interface 432 need not be an independent interface but may share an interface with the data I/O interface 120.

In FIG. 4, the storage controller 140 controls the operation in the storage device 100 using the control procedures as programs stored in the program memory 150. The program memory 150 stores the programs processed by the storage controller 140 and data used for the processing. The programs and data used in this embodiment include programs and data such as a storage configuration management program 151 that manages the configuration of the storage device 100, storage configuration information 152 that is the configuration information on the storage device 100, a client authentication program 153 that authenticates the access permission of the host computer 200 that accesses the data extent 110, and a data copy program 154 that copies data within the storage device or between storage devices. The program memory 150 is usually a magnetic disk, semiconductor memory, and so on.

On the other hand, the data extent 110 is a data storage area accessed by the host computer 200 via the storage network 400. The data extent 110 comprises a plurality of storage extents 115 so that the host computer 200 can use them. In this case, any number of, and any amount of, storage extents 115 may be used as long as they can be installed. Unless otherwise mentioned, a storage extent is called a data extent for convenience of description in this specification. The data extent 110 is usually a magnetic disk, a magnetic optical disk, a semiconductor memory, and so on.

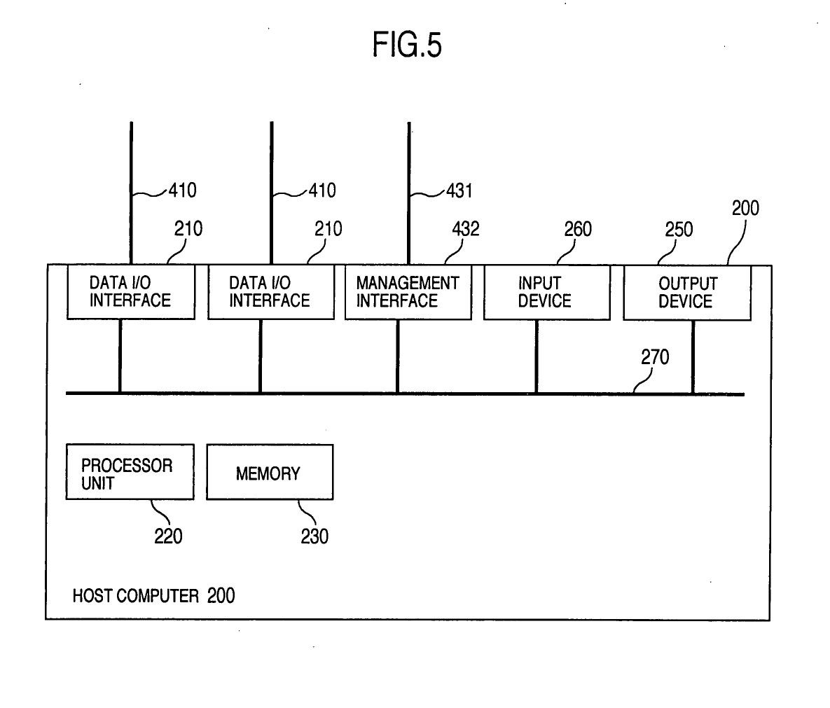

FIG. 5 is a diagram showing an example of the configuration of a host computer in this embodiment. The host computer 200 comprises data I/O interfaces 210, a management interface 432, an input device 260, an output device 250, a processor unit 220 such as a Central Processing Unit (CPU), and a memory 230 composed of a magnetic disk, a semiconductor memory, and so on. Those components are interconnected via a communication bus 270.

Referring to FIG. 5, the data I/O interfaces 210 are connected to the storage network 400 via the data I/O network paths 410 to send and receive data to and from the data extent 110. The management interface 432 is connected to the management network 430 via the management network path 431 to send and receive management information on the storage device 100 and the storage network 400. The data I/O interfaces 210 and the management interface 432 comprise network input/output devices compatible with Fibre Channel or Ethernet (registered trademark). Note that the management interface 432 need not be an independent interface but may share an interface with the data I/O interface 120.

On the other hand, the input device 260, to which devices such as a keyboard and a mouse not shown are connected, receives data the user keys in. The output device 250, to which a Liquid Crystal Display (LCD) and so on not shown are connected, outputs data processed by the processor unit 220. The host computer 200, an electronic computer, runs the operating system under which application programs such as a database or an accounting program run.

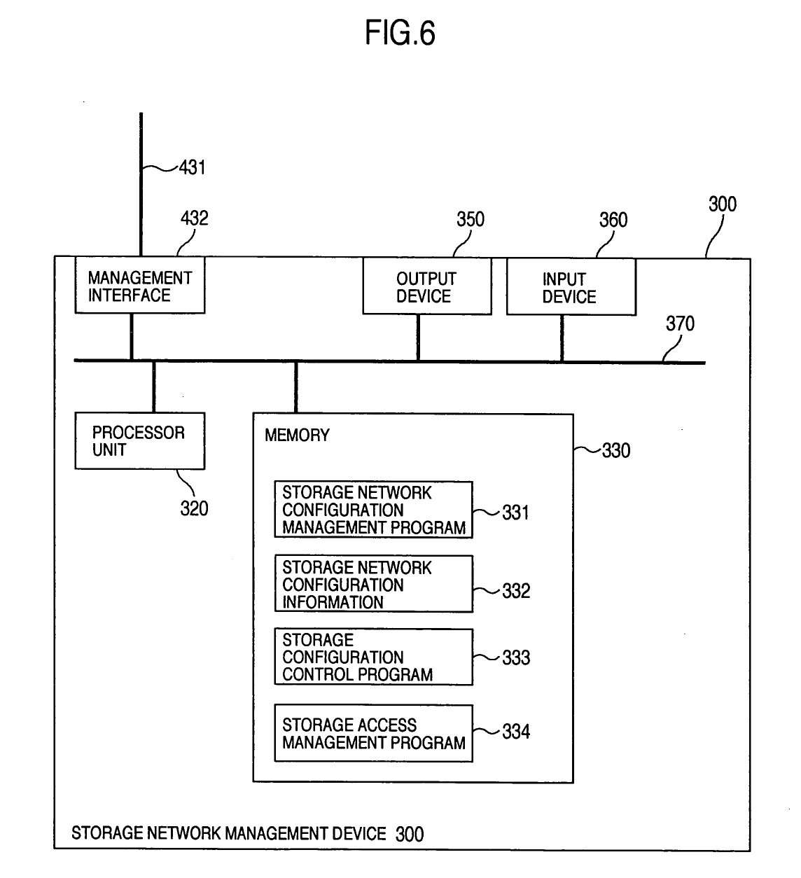

FIG. 6 is a diagram showing an example of the configuration of the storage network management device in this embodiment. The storage network management device 300 comprises a management interface 432, an input device 360, an output device 350, a processor unit 320 such as a CPU, and a memory 330 such as a magnetic disk, a semiconductor memory, and so on. Those components are interconnected via a communication bus 370.

Referring to FIG. 6, the management interface 432 is connected to the management network 430 via the management network path 431 to read and write management information on the storage device 100 and the storage network 400. The input device 360, to which the devices such as a keyboard and a mouse not shown are connected, receives data the user keys in. The output device 350, to which devices such as a LCD not shown are connected, outputs data processed by the processor unit 320.

The memory 330 stores the programs processed by the processor unit 320 and the data used during the processing. The programs and the data related to this embodiment include a storage network configuration management program 331 that manages the configuration of the storage network 400, storage network configuration information 332 that is the configuration information on the storage network 400, a storage configuration control program 333 that issues a configuration control instruction to the storage device 100, and a storage access management program 334 that manages access to a storage extent 115 on the storage device 100. The memory 330 is a magnetic disk, a semiconductor memory, and so on.

Like a general-purpose computer, the storage network management device 300 has the operating system under which the storage network configuration management program 331 and the storage access management program 334 run. The operating system is also a program stored in the memory 330.

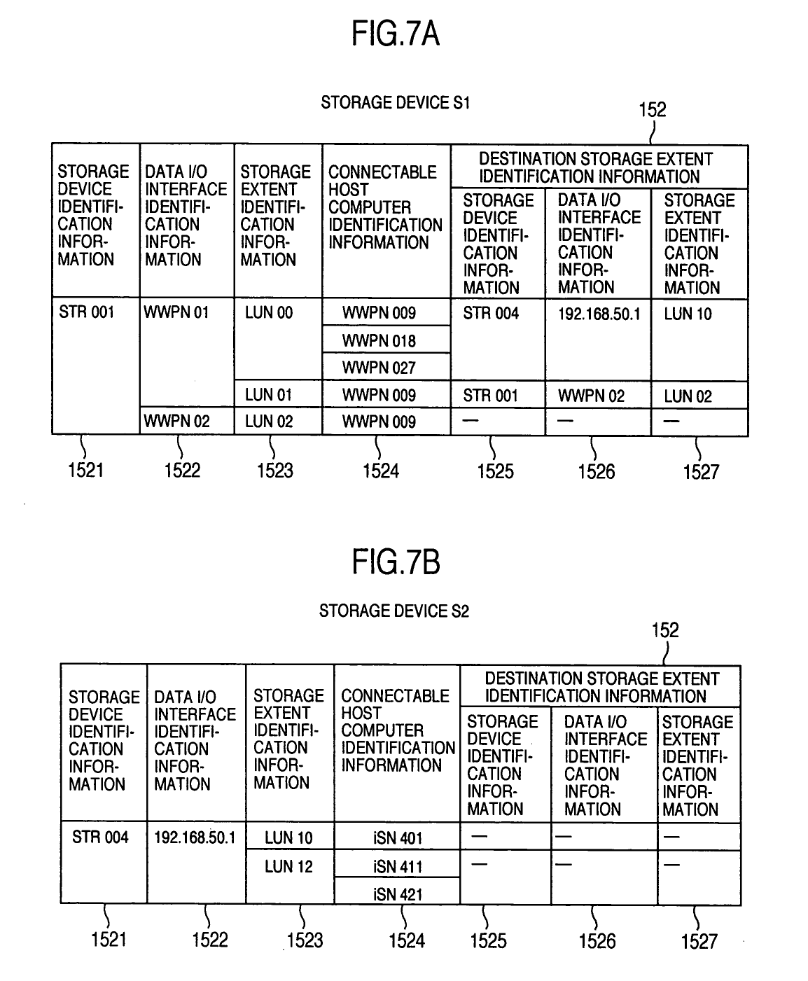

FIGS. 7A and 7B are diagrams showing examples of storage configuration information stored in a storage device. FIG. 7A shows storage configuration information on storage device S1, and FIG. 7B shows storage configuration information on storage device S2. The storage configuration information 152 comprises storage device identification information 1521, data I/O interface identification information 1522, storage extent identification information 1523, and connectable host computer identification information 1524.

The storage device identification information 1521, such as a hardware serial number, is information uniquely identifying the storage device 100. When the storage network 400 is an FC network, a World Wide Node Name (WWNN) is usually used as the storage device identification information 1521.

The data I/O interface identification information 1522 is information uniquely identifying the data I/O interface 120 installed on the storage device 100 specified by the storage device identification information 1521. When the storage network 400 is an FC network, a World Wide Port Name (WWPN) is usually used as the data I/O interface identification information 1522. When the storage network 400 is an iSCSI network (IP network), an IP address or a Media Access Control (MAC) address is usually used as the data I/O interface identification information 1522 as shown in FIG. 7B.

The storage extent identification information 1523 is information uniquely identifying the storage extent 115 accessed by the host computer 200. A logical volume identification parameter or a Logical Unit Number (LUN) is usually used as this information. The storage extent 115 indicated by the storage extent identification information 1523 is connected to the data I/O interface 120 indicated by the data I/O interface identification information 1522. Therefore, the host computer 200 accesses the storage extent 115 via the data I/O interface 120 to read data from or write data into the extent.

The connectable host computer identification information 1524 is information uniquely identifying the host computer 200 connectable to the storage extent 115 specified by the storage extent identification information 1523. That is, the connectable host computer identification information 1524 is used to specify the host computer 200 that can access the storage extent 115 specified by the storage extent identification information 1523. Usually, a WWPN is used as the connectable host computer identification information 1524 when the storage network 400 is a FC network, and an iSCSI name, an IP address, or a MAC address when the storage network 400 is an iSCSI network.

The storage configuration information 152 also includes destination storage extent identification information. That is, the destination storage extent identification information of the storage configuration information 152 comprises destination storage device identification information 1525, data I/O interface identification information 1526, and storage extent identification information 1527 so that the destination storage extent identification information corresponds to the source storage extent identification information.

FIGS. 7A and 7B will be described more in detail.

Referring to FIG. 7A, the storage device STR001 has two data I/O interfaces 120 (WWPN01, WWPN02). To the data I/O interface 120 indicated by WWPN01 that is one of two data I/O interfaces, two storage extents (LUN00, LUN01) are connected. Three host computers (WWPN009, WWPN018, WWPN027) 200 are registered in the connectable host computer identification information 1524 to indicate that those host computers can access the storage extent LUN00.

As shown in FIG. 7A, the destination storage extent identification information is specified for the storage extents (LUN00, LUN01) indicated in the storage extent identification information 1523. For example, the storage extent LUN10 of the storage device STR004 is specified as the destination storage extent corresponding to the storage extent LUN00 of the storage device STR001. Similarly, the storage extent LUN02 of the storage device STR001 is specified as the destination storage extent corresponding to the storage extent LUN01 of the same storage device STR001.

FIG. 7A shows an example of the storage configuration information 152 on the storage device 100 connected to an FC network, while FIG. 7B shows an example of the storage configuration information 152 on the storage device 100 connected to an iSCSI network. Therefore, the data I/O interface identification information 1522 and the connectable host computer identification information 1524 on the storage device 100 in FIG. 7A are represented by a WWPN that is a number uniquely identifying the data I/O interface 120 on the FC network. By contrast, the data I/O interface identification information 1522 on the storage device 100 in FIG. 7B is represented by IP network communication interface identification information such as an IP address and the connectable host computer identification information 1524 is represented by an iSCSI name.

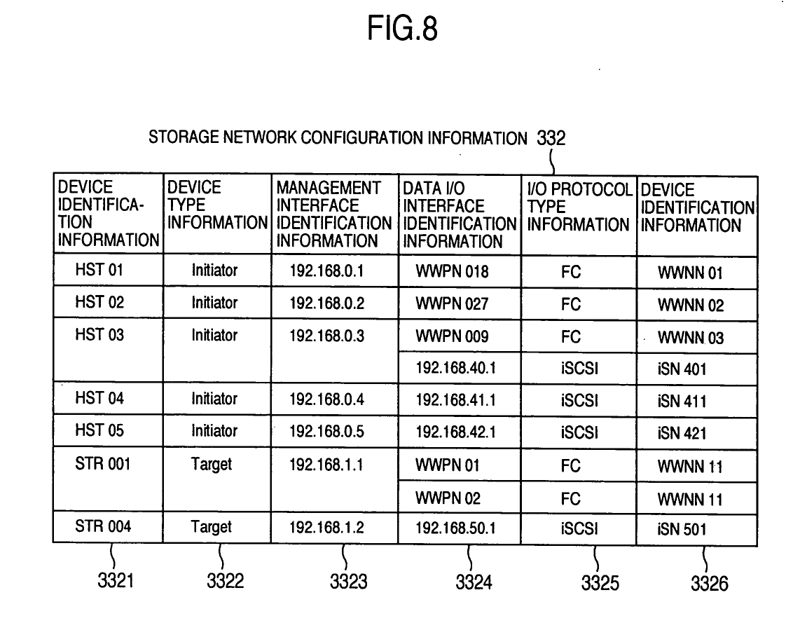

FIG. 8 is a diagram showing an example of storage network configuration information stored in the storage network management device. Referring to FIG. 8, the storage network configuration information 332 comprises device identification information 3321, device type information 3322, management interface identification information 3323, data I/O interface identification information 3324, I/O protocol type information 3325, and device identification information 3326.

Like the storage device identification information 1521 described above, the device identification information 3321 is identification information attached uniquely to the device such as a hardware serial number or the name of a computer used for the management network 430. The device type information 3322 is information indicating the type of a network component device when data is input or output according to the SCSI protocol via the storage network 400. For example, the host computer 200 is a SCSI initiator, and the storage device 100 is a SCSI target.

The management interface identification information 3323 is information uniquely identifying the management interface 432 of a device constituting the storage network 400 such as the storage device 100 and the host computer 200. Normally, an IP address is used for this information. The data I/O interface identification information 3324 is information uniquely identifying the data I/O interface 120 provided on a network component device. Normally, a WWPN, an iSCSI name, an IP address, or a MAC address is used for this information.

The I/O protocol type information 3325 is information indicating the type of the protocol used for the storage network 400. For example, this information indicates the type of the protocol, for example, Fibre Channel (FC) or iSCSI, used for the data I/O interface 120 indicated by the data I/O interface identification information 3324. The device identification information 3326 is information uniquely identifying the storage device 100 and the host computer 200 on the network. A WWNN used on an FC network or an iSCSI name on an iSCSI network is used for this information.

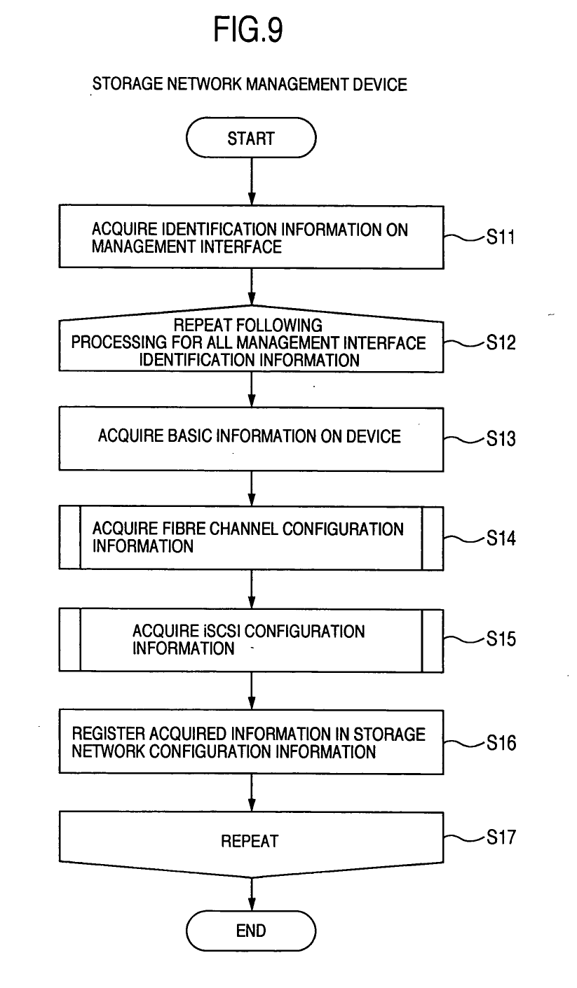

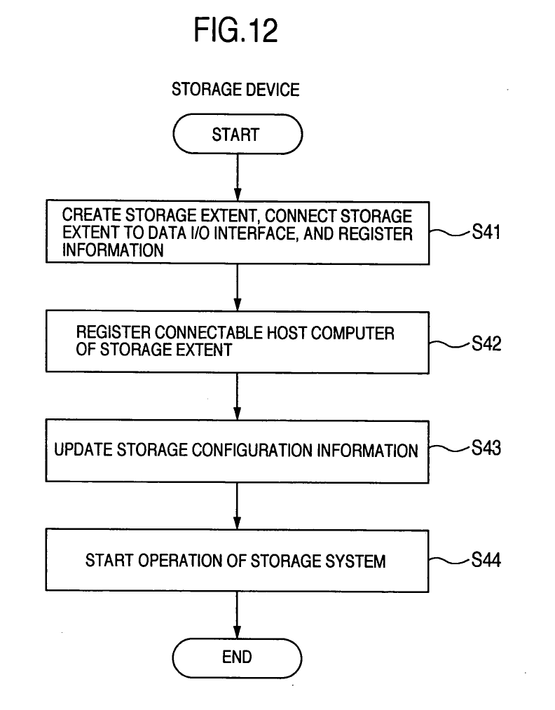

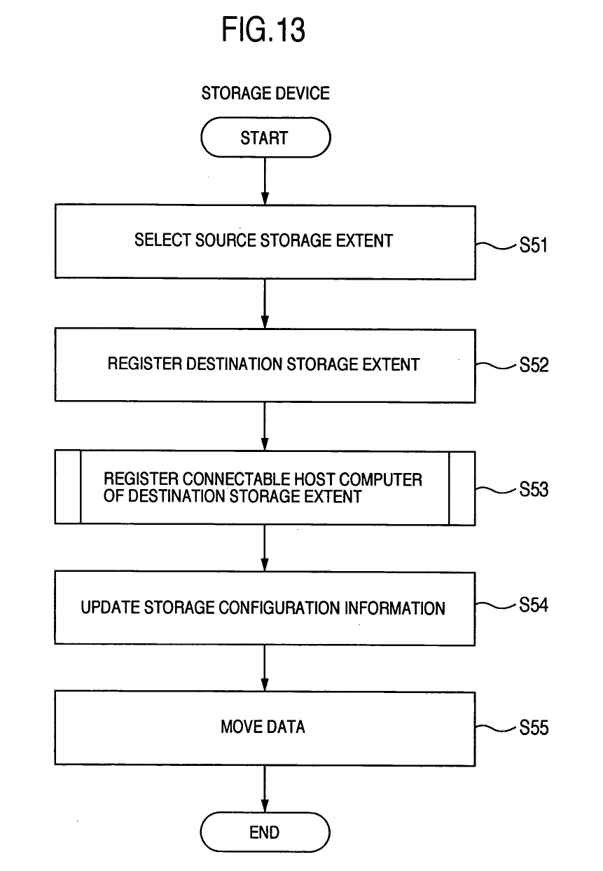

Next, with reference to the flowcharts in FIGS. 9-18, the operation of the storage device 100 and the storage network management device 300 in this embodiment will be described. First, FIGS. 9-11 show the procedure used by the storage network management device 300 for creating the storage network configuration information 332 shown in FIG. 8. FIG. 12 briefly shows the procedure used by the storage device 100 for configuring the storage extent 115 and for operating the storage system. FIGS. 13-18 show the procedure used when data is moved or copied from a source storage extent to a destination storage extent. This procedure is used primarily by the storage access management program 334 for registering the information on the host computer 200, which has access permission for the source storage extent, as the information on the connectable host computer 200 which has access permission for the destination storage extent.

FIG. 9 is a flowchart showing the procedure used by the storage network configuration management program of the storage network management device for creating the storage network configuration information.

Referring to FIG. 9, the processor unit 320 of the storage network management device 300 (hereinafter simply called the storage network management device 300) first acquires identification information on the management interfaces 432 of the devices, related to the migration of the storage device 100 (that is, storage device 100 and host computer 200), for creating the storage network configuration information 332 (step S11). The identification information on the management interfaces 432 may be either information entered by the system administrator from an input device such as the keyboard or information acquired by the storage network management device 300 by detecting a device connected to the management network 430 using the Simple Network Management Protocol (SNMP) as in the prior art. The storage network management device 300 registers the acquired information in the management interface identification information 3323.

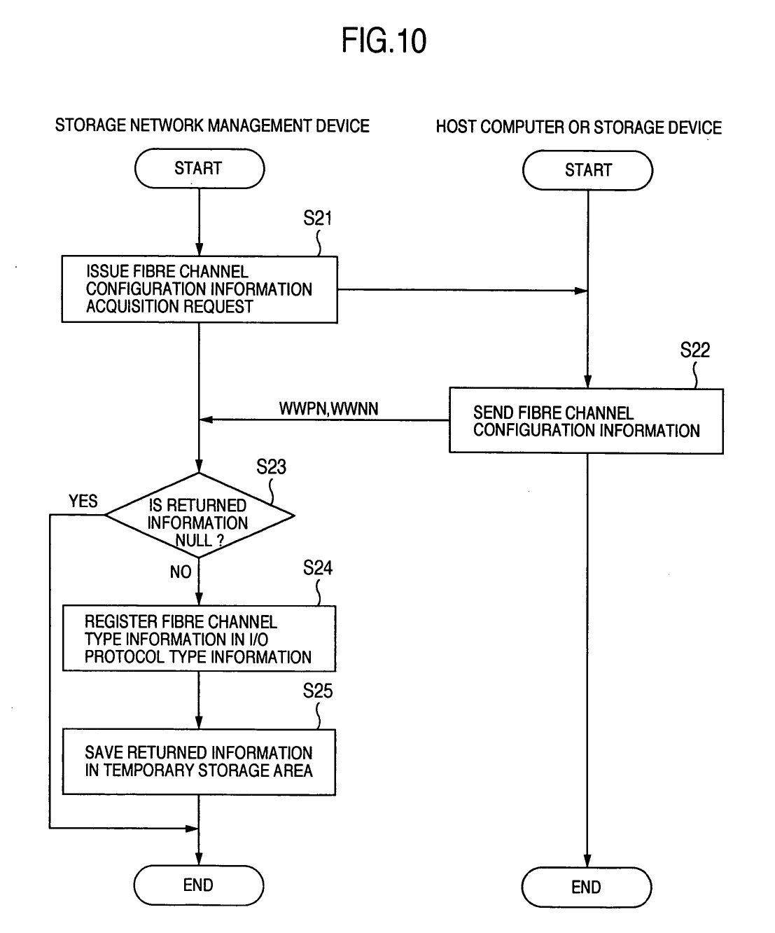

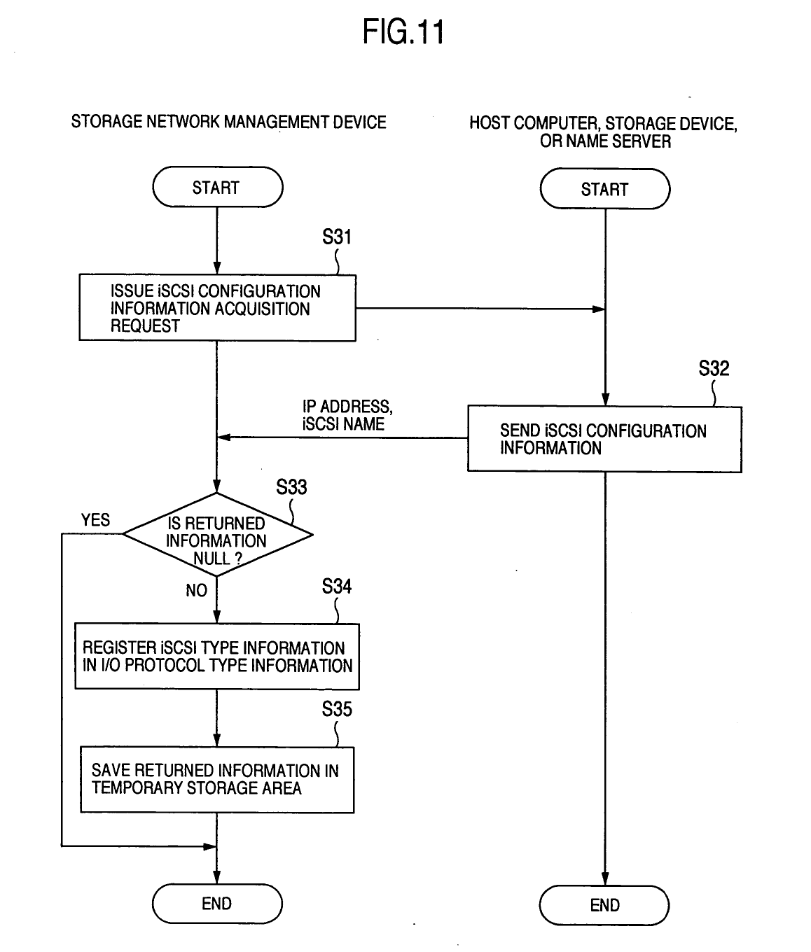

Next, the storage network management device 300 repeats the processing, from step S13 to step S17, for all the management interfaces 432, acquired in step S11, for acquiring the storage network configuration information (step S12). To do so, the storage network management device 300 first uses the conventional technology, such as SNMP, to acquire basic information such as device serial numbers (step S13). Then, the storage network management device 300 registers the acquired information in the device identification information 3321 and the device type information 3322. Next, the storage network management device 300 acquires the Fibre Channel configuration information related to the FC networks (step S14) and acquires the iSCSI configuration information related to the iSCSI networks (step S15). The detailed procedure executed in step S14 will be shown later in FIG. 10, and the detailed procedure executed in step S15 in FIG. 11. The processing in steps S14 and S15 acquires the data I/O interface identification information 3324, I/O protocol type information 3325, and device identification information 3326. The storage network configuration management information acquired as described above is registered in the storage network configuration information 332 (step S16). Step S17 is a step indicating the end of repetition.

FIG. 10 is a flowchart showing the detailed procedure for acquiring Fibre Channel configuration information shown in step S14 in FIG. 9. In FIG. 10, the storage network management device 300 issues a Fibre Channel configuration information acquisition request to specified one of the management interfaces 432 registered in step S11 in FIG. 9 (step S21). A storage network component device that receives this request, such as the host computer 200 or the storage device 100, returns Fibre Channel configuration information if the storage network 400 connected to the host computer 200 or the storage device 100 is an FC network (step S22). At this time, the storage network component device sends its WWNN as the device identification information 3326 and the WWPN of the data I/O interface 120 it owns as the data I/O interface identification information 3324. On the other hand, if the storage network component device is not connected to a Fibre Channel network, it returns a null message.

Next, the storage network management device 300 checks if the returned information is null (step S23) and, if the returned information is not null (NO in step S23), registers Fibre Channel type information in the I/O protocol type information 3325 (step S24). The storage network management device 300 saves the returned WWNN or WWPN in a temporary storage area allocated in the memory 330 (step S25). If it is determined in step S23 that the returned information is null, the storage network management device 300 skips steps S24 and step S25.

FIG. 11 is a flowchart showing the detailed procedure for acquiring iSCSI configuration information shown in step S15 in FIG. 9. In FIG. 11, the storage network management device 300 issues an iSCSI configuration information acquisition request to specified one of the management interfaces 432 registered in step S11 in FIG. 9 (step S31). This information may also be acquired by issuing an inquiry to the name server (iSNS server) 390 installed on the iSCSI network.

A storage network component device that receives the iSCSI configuration information acquisition request returns iSCSI configuration information if the storage network 400 connected to the storage network component device is an iSCSI network (step S32). If the request is issued to the name server 390 in step S31 to acquire the configuration information on the device that has the management interface identification information 3323, the iSNS server returns the iSCSI configuration information.

In step S32, the storage network component device or the name server sends the iSCSI name assigned to the storage network component device as the device identification information 3326, and the IP address of the data I/O interface 120 of the storage network component device as the data I/O interface identification information 3324. If the storage network component device is not connected to an iSCSI network, it returns a null message.

Next, the storage network management device 300 checks if the returned information is null (step S33) and, if the returned information is not null (NO in step S33), records the iSCSI type information in the I/O protocol type information 3325 (step S34). The storage network management device 300 saves the returned IP address and the iSCSI name in the temporary storage area allocated in the memory 330 (step S35). If it is found in step S33 that the returned information is null, the storage network management device 300 skips step S34 and step S35.

FIG. 12 is a flowchart showing the general procedure for operating a storage device. This procedure is a part of the storage configuration management program 151 (see FIG. 4). The storage controller 140 of the storage device 100 uses the storage configuration management program 151 to create a storage extent 115 based on the information for creating the storage extent 115 entered by the system administrator and, in addition, connects the created storage extent 115 to the data I/O interface 120 according to the instruction entered by the system administrator. The storage controller 140 registers the identification information on the storage extent 115 in the storage extent identification information 1523 (see FIG. 7) and, at the same time, registers the identification information on the data I/O interface 120, which is connected to the storage extent 115, in the data I/O interface identification information 1522 (step S41).

Next, the storage controller 140 registers the identification information on the host computer 200, to which access permission for the storage extent 115 created in step S41 is to be assigned, in the connectable host computer identification information 1524 according to the information entered by the system administrator (step S42). The configuration of the storage device 100 is changed by reflecting the information registered in step S41 and step S42 onto the storage configuration information 152 (step S43). Then, the storage device 100 is ready for operation and the operation starts (step S44).

When the operation starts and the host computer 200 sends a data input/output request to the storage extent 115, the storage controller 140 uses the client authentication program 153 (see FIG. 4) to authenticate the host computer 200 to check if the access is allowed. If it is found as the result of the checking that the identification information on the host computer 200 is not recorded in the connectable host computer identification information 1524, the storage controller 140 rejects the access from the host computer 200 to the storage extent 115.

FIG. 13 is a flowchart showing the processing procedure for migrating data among a plurality of storage extents. The procedure executed by the storage device 100 of the source is a part of the storage configuration management program 151 (see FIG. 4). First, the storage controller 140 of the storage device 100 selects the storage extent 115, which is the source, according to the information entered by the system administrator and sets the selected storage extent as a source storage extent 111 (step S51). Next, the storage controller 140 registers the storage extent 115, which is the destination of the storage extent 115 selected in step S51, according to the information entered by the system administrator and sets the registered storage extent 115 as a destination storage extent 112 (step S52). The destination storage extent 112 may or may not be on the same storage device as that on which the source data extent 111 is stored. In step S52, the system administrator enters the storage device identification information 1525, the data I/O interface identification information 1526, and the storage extent identification information 1527 of the destination.

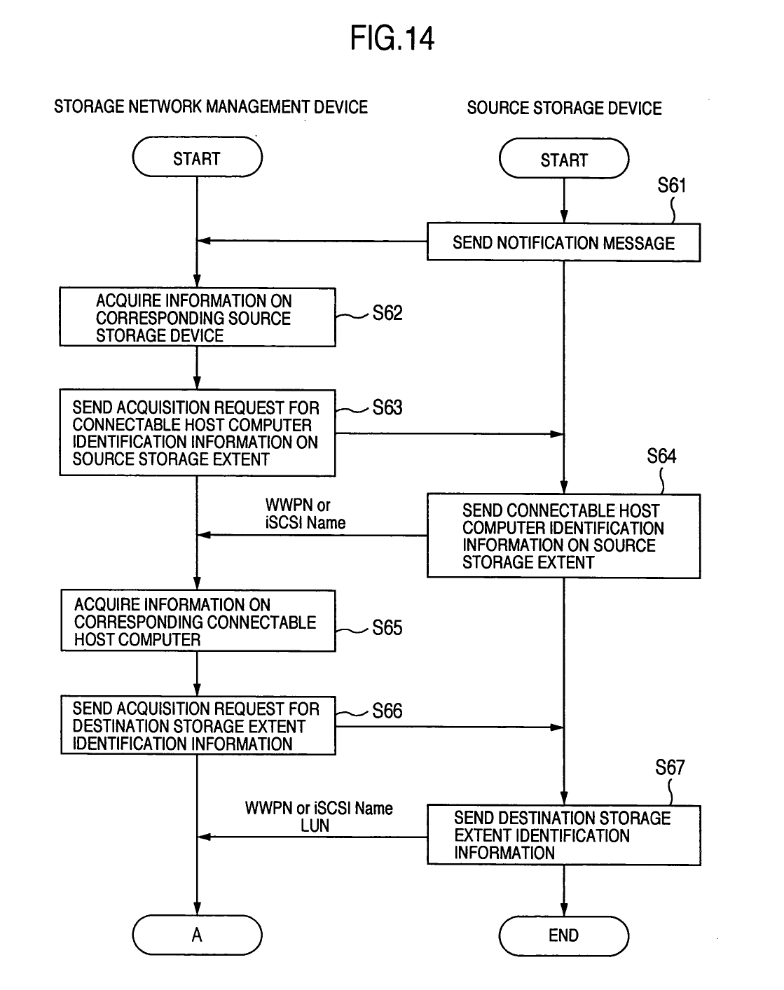

Based on the information entered in the above steps, the storage controller 140 of the storage device 100 selects the connectable host computer 200 for the destination storage extent 112 and registers it (step S53). The detailed procedure of step S53 will be described later with reference to FIG. 14-FIG. 18.

By reflecting the destination storage extent identification information and the connectable host computer identification information 1524 registered by above procedure onto the storage configuration information 152, the configuration of the storage device 100 of the destination is changed (step S54). In addition, the data copy program 154 is executed to move data from the source storage extent 111 to the destination storage extent 112 (step S55).

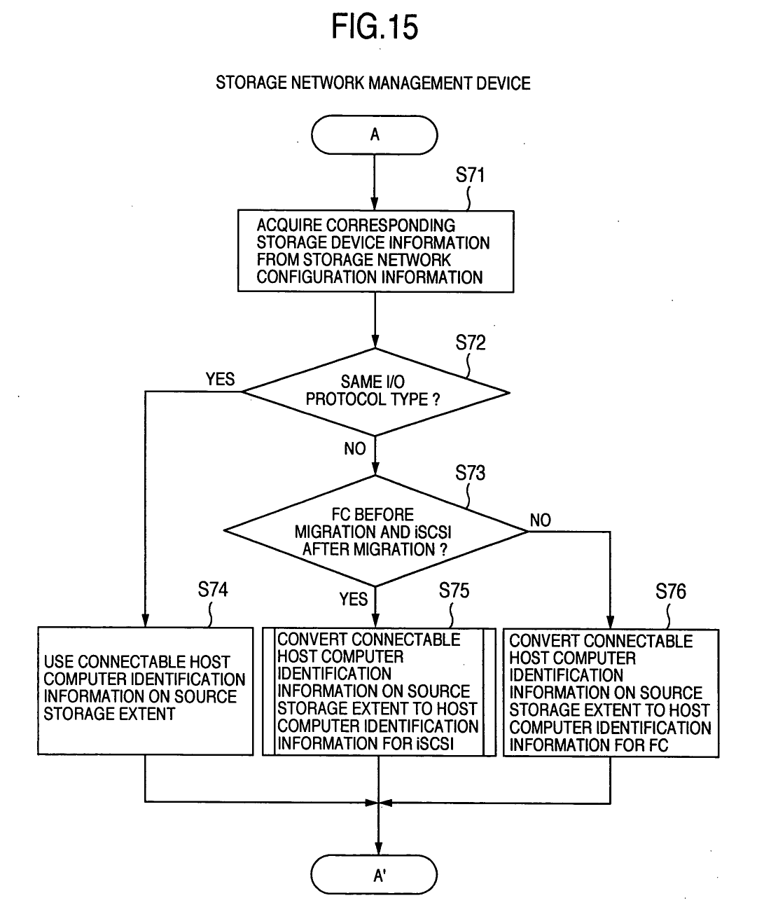

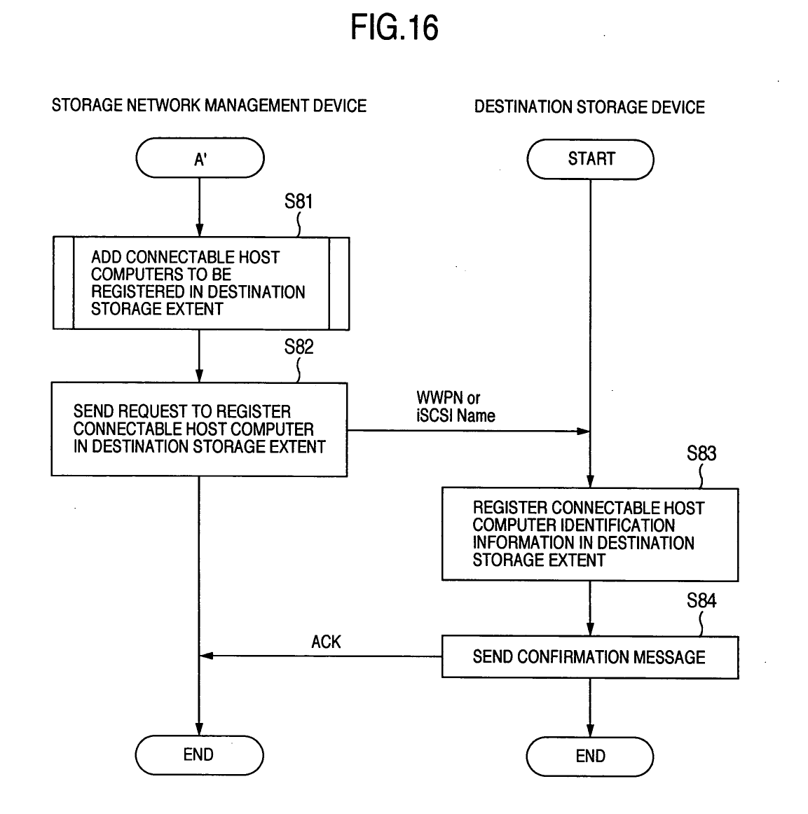

Next, with reference to FIGS. 14-16, the processing procedure for registering the connectable host computer identification information 1524 in the destination storage extent 112 will be described. FIG. 14 is a flowchart showing the procedure used by the storage network management device for acquiring storage management information from the source storage device when the connectable host computer identification information is registered in the destination storage extent. FIG. 15 is a flowchart showing the procedure for converting the host computer identification information when the connectable host computer identification information is registered in the destination storage extent. FIG. 16 is a flowchart showing the procedure used by the destination storage device for registering the connectable host computer identification information in the destination storage extent based on the information sent from the storage network management device when the connectable host computer identification information is registered in the destination storage extent.

In FIG. 14, when the information on the destination storage extent 112 is registered in step S52 in FIG. 13, the storage device 100 of the source sends a notification message to the storage network management device 300 indicating that the information is registered (step S61). To this notification message, the storage device identification information 1521 (see FIG. 7), the data I/O interface identification information 1522, and the storage extent identification information 1523 of the source storage extent 111 entered in step S51 are attached.

At this time, the communication protocol used between the storage network management device 300 and the storage device 100 is SNMP or Hyper Text Transfer Protocol (HTTP). The data format of the communication is an existing method such as Management Information Base (MIB) or Common Information Model (CIM). Similarly, the notification means used is an SNMP trap or a CIM Indication.

Next, the storage network management device 300 uses the storage access management program 334 to search the storage network configuration information 332 to acquire the device identification information corresponding to the storage device identification information 1521 attached to the notification message (step S62). The storage network management device 300 acquires the management interface identification information 3323 of the storage device specified by the storage device identification information 1521 attached to the notification message. The storage network management device 300 further sends an acquisition request message to the management interface 432 of the storage device 100 acquired in step S62 to request it to send the connectable host computer identification information 1524 registered in the source storage extent 111 (step S63). To this acquisition request message, the source storage extent identification information attached in step S61, that is, the storage device identification information 1521, the data I/O interface identification information 1522, and the storage extent identification information 1523, are attached.

The source storage device 100, which receives this acquisition request message, searches the storage configuration information 152 and sends the connectable host computer identification information 1524, corresponding to the specified storage extent identification information 1523 and registered by WWPN or iSCSI name, to the storage network management device 300 (step 64).

Next, the storage network management device 300, which receives the connectable host computer identification information 1524, searches the storage network configuration information 332 to acquire the configuration information on the host computer 200 and saves the acquired information in the temporary storage area allocated in a part of the memory 330 (step S65). Then, the storage network management device 300 sends a request to acquire the destination storage extent identification information, registered in the source storage extent 111, to the storage device 100 (step S66). To this acquisition request message, the source storage extent identification information received by the message in step S61, that is, the storage device identification information 1521, the data I/O interface identification information 1522, and the storage extent identification information 1523, is attached.

The source storage device 100 receives the acquisition request message, searches the storage configuration information 152 based on the received information, and sends the storage device identification information 1525, the data I/O interface identification information 1526, and the storage extent identification information 1527 registered in the specified storage extent destination (step S67).

Next, the storage network management device 300 receives the information sent from the source storage device 100 in step S67, searches the storage network configuration information 332 for the storage device 100 including the destination storage extent 112 based on the received information, and stores it in the temporary storage area (step S71 in FIG. 15). This temporary storage area is a storage area allocated in a part of the memory 330.

After executing the above procedure, the storage network management device 300 has saved the storage device identification information 1521, the data I/O interface identification-information 1522, the storage extent identification information 1523, and the connectable host computer identification information 1524 of the source storage extent 111 acquired in step S62 and step S65 and the storage device identification information 1525, the data I/O interface identification information 1526, and the storage extent identification information 1527 of the destination storage extent 112 acquired in step S71.

Next, in FIG. 15, the storage network management device 300 uses the storage access management program 334 (see FIG. 6) to start processing for selecting the host computer 200 to be connected to the destination storage extent 112. First, the storage network management device 300 compares the protocol type of the data I/O interface 1522 to which the source storage extent 111 is connected with the protocol type of the data I/O interface 1526 to which the destination storage extent 112 is connected (step S72). For the protocol type of the data I/O interface 120, the I/O protocol type information 3325 in the storage network configuration information 332 should be referenced because it is already stored there. For example, when “WWPN01” is registered in the data I/O interface identification information 1522 for the source storage extent 111, the protocol type is “FC”, that is, a fibre channel”, as shown in FIG. 8. Similarly, when the data I/O interface identification information 1526 is “192.168.50.1”, the protocol type is “iSCSI”.

If it is found, as the result of the checking in step S72, that the type of the data I/O interface 120 of the source matches the type of the data I/O interface 120 of the destination (YES in step S72), the connectable host computer identification information 1524 for the source storage extent 111 is used directly for the connectable host computer identification information 1524 for the destination storage extent 112 and the connectable host computer identification information 1524 is saved in the temporary area (step S74). This temporary storage area is a storage area allocated in a part of the memory 330.

On the other hand, if it is found, as the result of the checking in step S72, that the protocol type of the data I/O interface 120 of the source does not match the protocol type of the data I/O interface 120 of the destination (NO in step S72), it is checked whether the I/O protocol type of the source storage extent 111 is Fibre Channel and whether the I/O protocol type of the destination storage extent 112 is iSCSI (step S73).

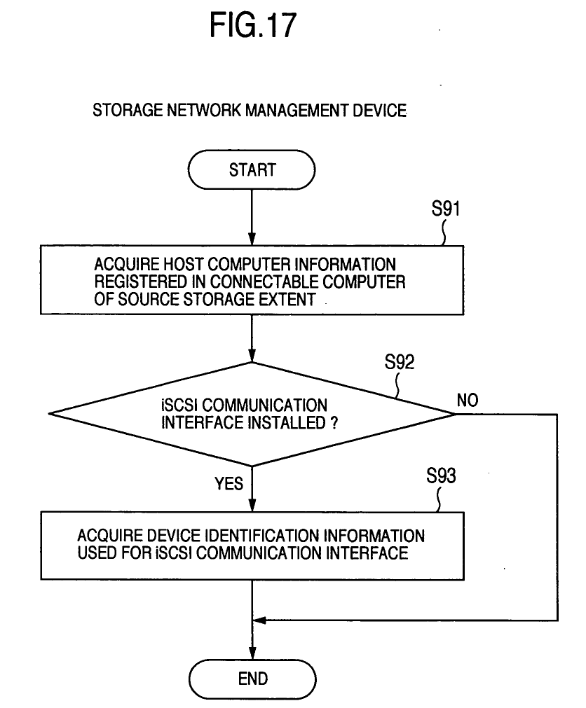

If it is found, as the result of the checking in step S73, that the I/O protocol type of the source storage extent 111 is Fibre Channel and the I/O protocol type of the destination storage extent 112 is iSCSI (YES in step S73), the storage network management device 300 converts the connectable host computer identification information 1524 for Fibre Channel registered in the source storage extent 111 to the host computer identification information for iSCSI and uses the converted information as the connectable host computer identification information 1524 for the destination storage extent 112 (step S75). For example, in the processing in step S75, the host computer identification information for Fibre Channel represented by a WWPN is converted to the identification information for iSCSI represented by an iSCSI name. The processing in step S75 will be described more in detail with reference to FIG. 17.

If the checking result in step S73 is negative (NO in step S73), it is assumed that the I/O protocol type of the source storage extent 111 is iSCSI and that the I/O protocol type of the destination storage extent 112 is Fibre Channel. In this case, the storage network management device 300 converts the connectable host computer identification information 1524 for iSCSI registered in the source storage extent 111 to a host computer identification information for Fibre Channel and uses the converted information for the connectable host computer identification information 1524 of the destination storage extent 112 (step S76).

After executing the procedure described above, the host computer identification information to be registered in the destination storage extent 112 is acquired based on the connectable host computer 200 registered in the source storage extent 111. FIG. 16 shows the processing procedure for adding another host computer 200 on the destination storage network (N2) 401 to the connectable host computer 200 and then reflecting the configuration on the destination storage device 100.

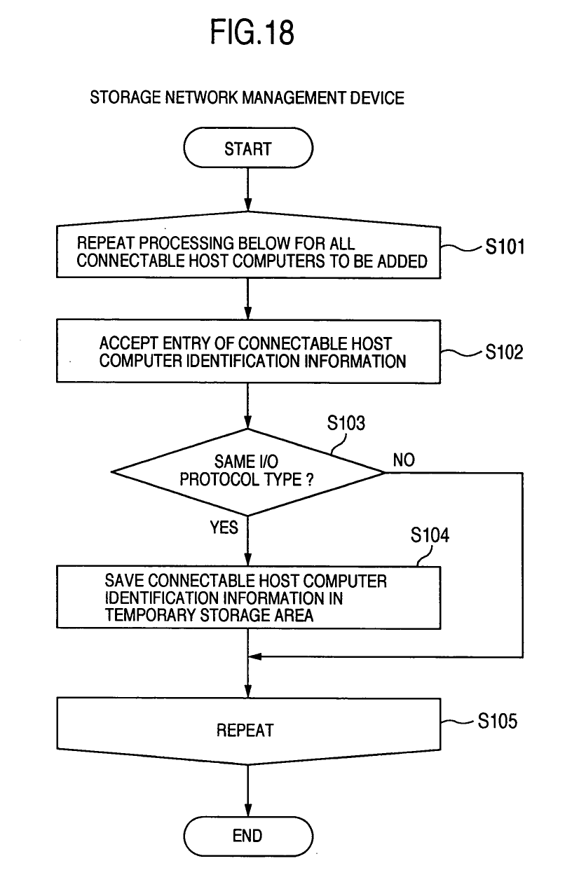

The storage network management device 300 adds a connectable host computer 200 to be registered in the destination storage extent 112 based on the input information input by the system administrator (S81). The processing in step S81 will be described more in detail with reference to FIG. 18.

As the result of the processing in step S74, step S75 or step S76, and in step S81 described above, identification information on one or more connectable host computers 200 to be registered in the destination storage extent 112 is stored in the temporary storage area. Then, the storage access management program 334 (see FIG. 6) of the storage network management device 300 requests the storage configuration control program 333 to register the temporarily-stored identification information on the connectable host computers 200 in the destination storage extent 112. The storage configuration control program 333 searches the storage network configuration information 332 for the management interface identification information 3323 on the destination storage device 100 (S2). In addition, the storage configuration control program 333 sends the connectable host computer identification information (WWPN or iSCSI name) to the management interface 432 to request that the information be registered in the destination storage extent 112 (step S82).

The destination storage device 100 (S2), which accepts the request of registration in the destination storage extent 112, registers the connectable host computer identification information 1524 attached to the request message in the specified storage extent 115 and, at the same time, updates the storage configuration information 152 (step S83). In addition, to notify the completion of step S83, the destination storage device 100 returns a confirmation message to the storage network management device 300 (step S84).

FIG. 17 is a flowchart showing the detailed processing procedure in step S75 in FIG. 15 where host computer identification information for FC is converted to host computer identification information for iSCSI. Referring to FIG. 17, the storage network management device 300 first uses the storage access management program 334 to search the storage network configuration information 332 using the connectable host computer identification information, registered in the source storage extent 111, as the key and acquires the configuration information on the host computer 200 (step S91).

In the example in FIG. 7, “WWPN009” used for Fibre Channel is registered as the connectable host computer identification information. Searching the storage network configuration information 332 for WWPN009 gives the entry “HST03” where “WWPN009” is stored. Next, whether the device has the data I/O interface 120 for iSCSI is checked (step S92). In the example in FIG. 8, because the network configuration device “HST03” has “192.168.40.1”, which is the data I/O interface 210, and its I/O protocol type is iSCSI, control is passed to the next step S93. In the next procedure, the device identification information 3326 corresponding to the data I/O interface 210 for iSCSI provided on the host computer 200 is acquired (step S93). In the example in FIG. 8, the device identification information on the host computer 200 corresponding to “HST03” is recorded as “iSN401” for iSCSI. By performing the above processing, the device identification information 3326 for iSCSI, owned by the connectable host computer 200 for Fibre Channel, can be acquired.

FIG. 18 is a flowchart showing the detailed processing procedure for selecting additional connectable host computers in step S81 in FIG. 16. The system manager of the storage network management device 300 can use this processing procedure to add host computers 200 to be connected to the destination storage extent 112. In FIG. 18, the storage network management device 300 repeats step D102 to step S105 the number of times the system administrator enters additional host computers 200 (step S101).

First, the storage network management device 300 accepts the entry of the device identification information 3326 or the data I/O interface identification information 3324 of a connectable host computer entered by the system administrator (step S102). At this time, the storage network management device 300 uses the storage access management program 334 to check if the entered host computer 200 has the data I/O interface 210 corresponding to the same I/O protocol type as that of the data I/O interface 120 connected to the destination storage extent 112 (step S103).

If it is found, as the result of the checking, that the protocol type is the same (YES in step S103), the storage network management device 300 permits the addition of the entered host computer 200 and saves the device identification information 3326 in the temporary storage area (step S104). This temporary storage area is a storage area allocated in a part of the memory 330. If it is found, as the result of the checking in step S103, that the protocol type is not the same (NO in step S103), the processing in step S104 is skipped. Step S105 is a step indicating the end of repetition.

As described above, the storage network management device 300 and the management network 430 are provided in the first embodiment to migrate the storage devices 100 or the storage network 400, and the storage network management device 300 is connected via the management network 430 to all storage devices 100 and host computers 200 involved in the migration. This configuration allows the storage network management device 300 to acquire configuration information related to the network from all storage devices 100 and host computers 200 related to the migration. This configuration also makes it easy to establish the connection relation between the storage devices 100 and host computers 200 at the destination and those at the source.

Therefore, even if different protocols are used in the storage network when the storage device 100 or the storage network 400 is migrated, the system administrator can perform migration simply by entering information associating the storage extents 115 of the storage devices at the source with those of the storage devices at the destination. Furthermore, the migration of access control information on the storage extents 115, which is extremely cumbersome in the conventional method, can be performed at the same time. As a result, the workload on the system administrator is significantly reduced.

### Second Embodiment

Next, a second embodiment of the present invention will be described in detail with reference to FIGS. 19-22.

FIG. 19 is a diagram schematically showing the migration of a storage network in the second embodiment. In the second embodiment, a storage device 100 and data extents 110 are not migrated but a host computer 200 is migrated. As the host computer 200 is migrated, the communication path connecting the storage device 100 and the host computer is migrated from a communication path 403 to a communication path 404. This means that the storage network is migrated.

That is, in the second embodiment, when a host computer 200a is migrated to a host computer 200b as shown in FIG. 19, a data I/O interface 122, to which the storage extent 115 is connected, is selected and registered so that its I/O protocol type is the same as that of the data I/O interface 212 on the desstination host computer 200b. Means for selecting and registering such a data I/O interface is provided.

Assume that the system configuration of the storage network shown in FIGS. 3-8 in the first embodiment is also used in this embodiment. The processing procedures used in the storage network management device 300 shown in FIGS. 9-11 and the basic operation procedure for the storage device 100 shown in FIG. 12 are also the same as those in the first embodiment.

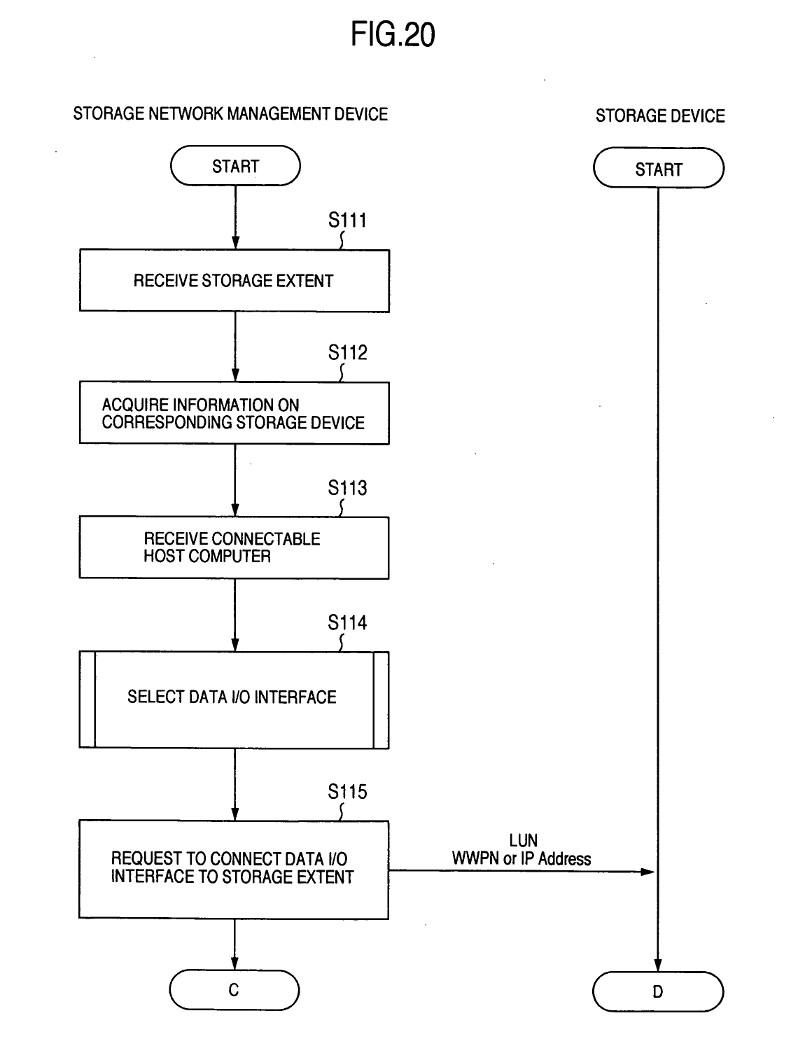

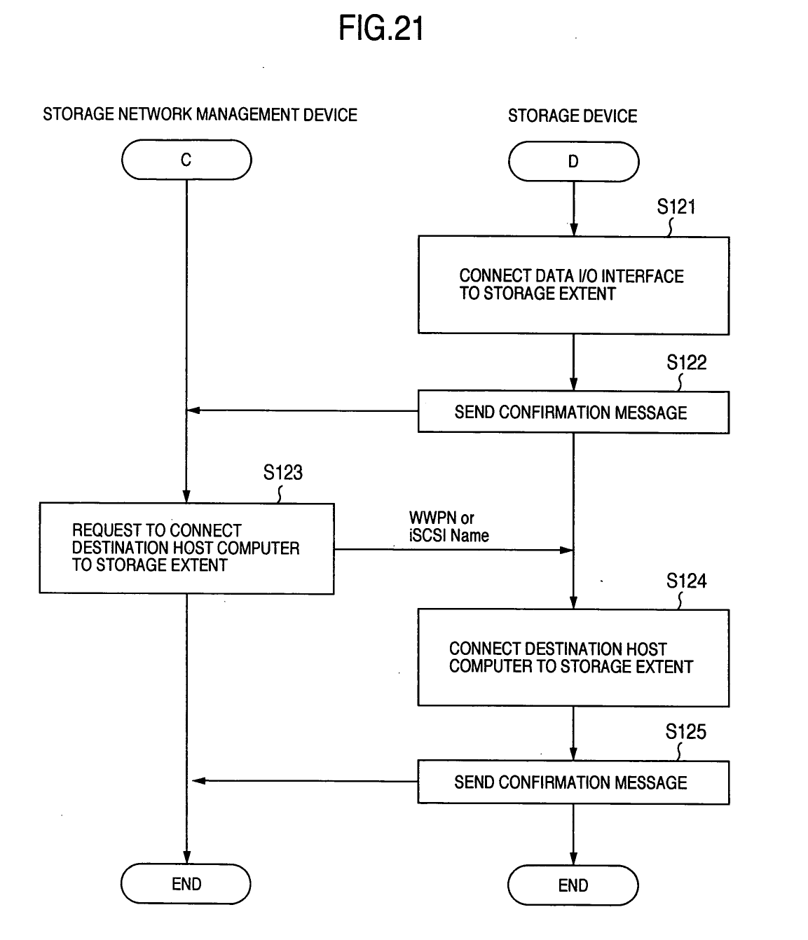

FIG. 20 and FIG. 21 are flowcharts showing the processing procedure for migrating a connection to a storage extent to a host computer that is different from the host computer currently in operation. In FIG. 20, the storage network management device 300 receives identification information on the storage extent 115, connected to a source host computer 201, according to the information entered by the system administrator (step S111). In S111, the system administrator should enter the storage device identification information 1521, data I/O interface identification information 1522, and storage extent identification information 1523 on the storage extent 115. The received information is stored in the temporary storage area allocated by the storage access management program 334 in a part of the memory 330.

Next, the storage network management device 300 uses the storage access management program 334 to search the storage network configuration information 332 for the configuration information on the storage device 100 specified in step S111 and stores the acquired information in the temporary storage area allocated in a part of the memory 330 (step S112). In addition, the storage network management device 300 receives the destination host computer 200 entered through the input operation of the system administrator (step S113). In this step, the system administrator should enter the device identification information 3321 or the management interface identification information 3323 on the host computer 200.

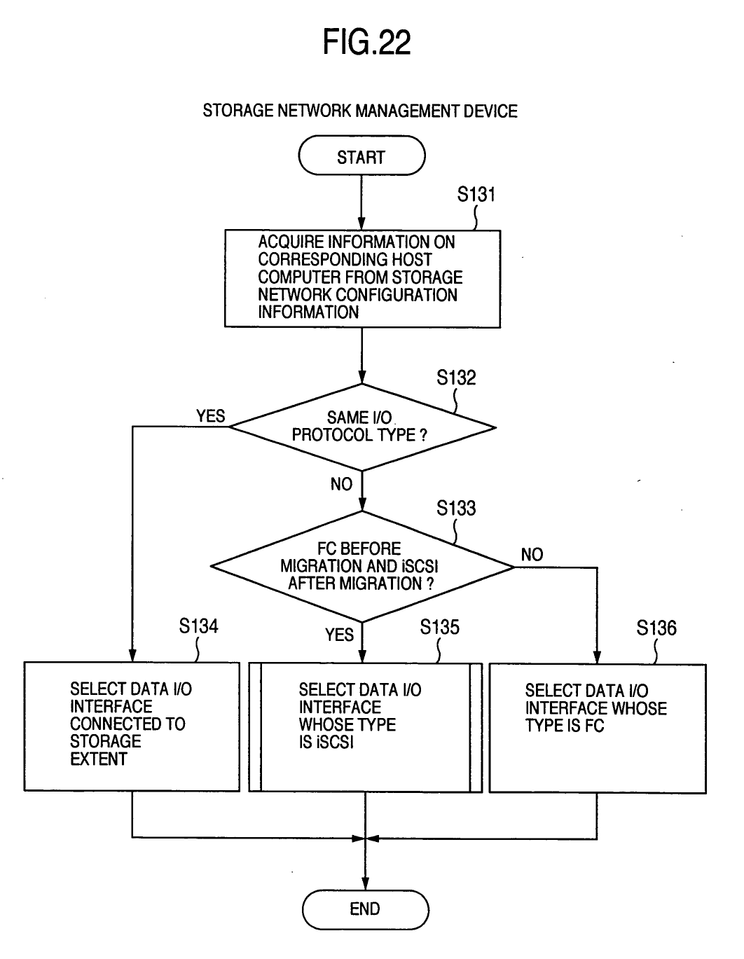

Next, the storage network management device 300 selects the data I/O interface 120 of the storage device 100 to which the host computer 200 entered in step S112 is connected (S114). The detailed procedure executed in step S114 will be described later with reference to FIG. 22. In addition, the storage access management program 334 of the storage network management device 300 requests the storage configuration control program 333 to connect the data I/O interface 120 selected in step S114 to the storage extent 115 entered in step S11l. The storage network management device 300 uses the storage configuration control program 333 to issue an I/O interface connection request message to the address indicated by the management interface identification information 3323 of the storage device 100 acquired in step S112 (step S115). To this request message, the identification information on the storage extent 115 entered in step S11l and the data I/O interface identification information 3324 selected in step S114 are attached.

Next, in FIG. 21, the storage device 100, which receives the connection request message issued by the storage network management device 300 in step S115, connects the requested data I/O interface 120 to the storage extent 115 (step S121). At the same time, the result is reflected on the storage configuration information 152. In addition, the storage device 100 sends a message to the storage network management device 300 to confirm that the processing is terminated normally (step S122).

Next, the storage network management device 300 uses the storage configuration control program 333 to send a request message to request that the host computer 200 entered in step S113 be connected to the storage extent 115 entered in step S11l (step S123). To this request message, the identification information on the host computer 200 to be acquired in step S131, which will be described later, is attached. For example, a WWPN for Fibre Channel or an iSCSI name is attached.

The storage device 100 connects the host computer 200 attached to the request message to the storage extent 115 and, at the same time, registers the host computer in the connectable host computer identification information 1524 of the storage configuration information 152 (step S124). In addition, the storage device 100 sends a confirmation message to the storage network management device 300 to confirm that the processing is terminated normally (S125).

FIG. 22 is a flowchart showing the detailed procedure in step S114 in FIG. 20 where a data I/O interface connected to the storage extent 115 is acquired. Referring to FIG. 22, the storage network management device 300 uses the storage access management program 334 to search the storage network configuration information 332 using the host computer identification information 3321 or the management interface identification information 3323 entered in step S113 as the key, for the configuration on the host computer 200 (step S131). Next, the storage network management device 300 checks if the I/O protocol type information 3325 on the data I/O interface 120 connected to the storage extent 115 acquired in step S112 matches the I/O protocol type information 3325 on the data I/O interface 210 on the host computer 200 acquired in step S131 (step S132).

For example, assume that the storage extent LUN00 connected to the data I/O interface WWPN01 on the storage device STR001 in FIG. 7 is entered in step S11l (see FIG. 20). Then, in step S112, it is found that the I/O protocol type of the data I/O interface WWPN01 of the storage device STR001 in FIG. 8 is “FC”. On the other hand, assume that the host computer 200 entered in step S113 is “HST03” in FIG. 8. Then, the result of step S131 indicates that the I/O protocol types of the data I/O interface “WWPN09” and “192.168.40.1” are “FC” and “iSCSI” respectively. In step S132, the storage network management device 300 compares and determines the I/O protocol types.

If it is found in step S132 that the I/O protocol type of the data I/O interface 120 connected to the storage extent 115 before the host computer migration matches the I/O protocol type of the data I/O interface 212 installed on the host computer 200 after the host migration (YES in step S132), the storage network management device 300 selects the data I/O interface 120 connected to the storage extent 115 and stores it in the temporary storage area allocated in a part of the memory 330 (step S134).

On the other hand, if it is found in step S132 that the I/O protocol type of the data I/O interface 121 connected to the storage extent 115 does not match the I/O protocol type of the data I/O interface 212 on the destination host computer 200 (NO in step S132), the storage network management device 300 further checks the following. That is, the storage network management device 300 checks if the I/O protocol type of the data I/O interface 120 connected to the storage extent 115 before the host computer migration is “FC”, that is, Fibre Channel, and if the I/O protocol type of the data I/O interface 212 installed on the destination host computer 200 is “iSCSI” (step S133).

If it is found in step S133 that the I/O protocol type of the data I/O interface 120 connected to the storage extent 115 is Fibre Channel and that the I/O protocol type of the data I/O interface 212 installed on the destination host computer 200 is “iSCSI” (YES in step S133), the storage network management device 300 selects the data I/O interface 120 whose I/O protocol type is “iSCSI” from the data I/O interfaces 120 installed on the storage device 100 in which the storage extent 115 is stored and saves the selected data I/O interface in the temporary storage area allocated in a part of the memory 330 (step S135). On the other hand, if it is found in step S133 that the I/O protocol type of the data I/O interface 120 connected to the storage extent 115 is iSCSI and if the I/O protocol type of the data I/O interface 212 installed on the destination host computer 200 is Fibre Channel (NO in step S133), the storage network management device 300 selects the data I/O interface 120 whose I/O protocol type is “FC” from the data I/O interfaces 120 installed on the storage device 100 in which the storage extent 115 is stored and saves the selected data I/O interface in the temporary storage area allocated in a part of the memory 330 (step S136).

As described above, the second embodiment is a special case of the first embodiment; that is, there is only one storage device 100 in the configuration of the storage network of the first embodiment. Therefore, as shown in FIG. 20 and FIG. 21, the storage access management program 334 of the storage network management device 300 is simplified. Other operation and effect of this embodiment are the same as those of the first embodiment.

### First Modification 1 of Embodiment

A modification of the first embodiment and the second embodiment of the present invention described above is provided wherein the storage network management device 300 is not provided in the storage network system of the first or second embodiment but the host computer 200 works also as the storage network management device 300.

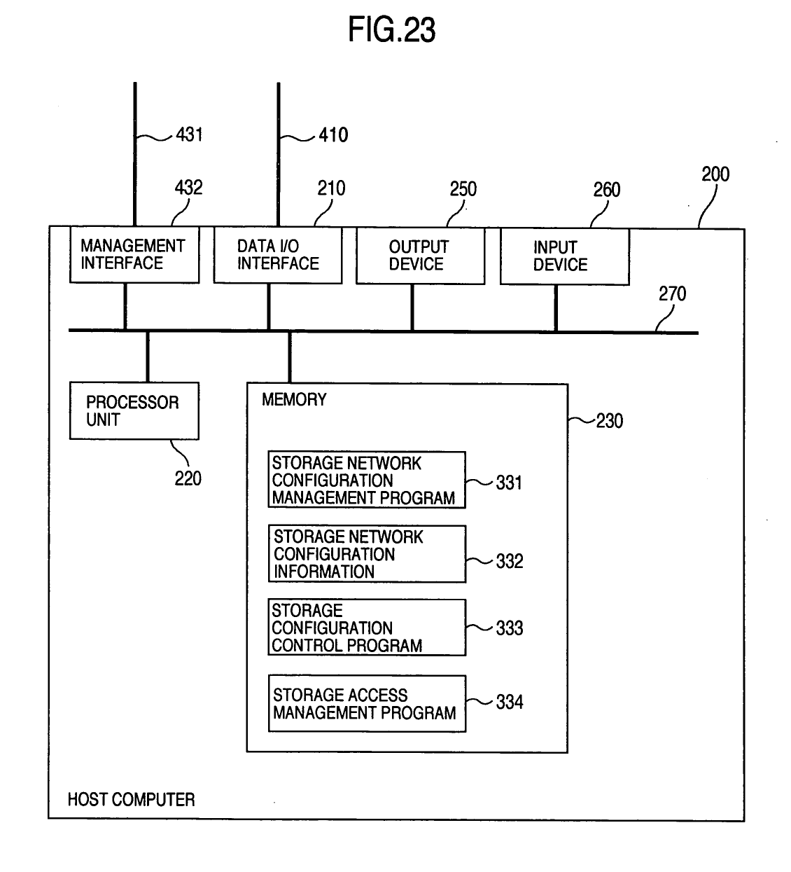

FIG. 23 is a diagram showing the configuration of a host computer when the host computer works also as the storage network management device. In this case, the host computer 200 comprises a storage network configuration management program 331, a storage network configuration information 332, a storage configuration control program 333, and a storage access management program 334 as shown in FIG. 23. The function and the processing procedure of those programs are the same as those of the programs shown in the first or second embodiment. In this modification of the embodiments, it is also possible that the management interface 432 and the management network 430 are not provided but the storage network 400 works also as the management network 430.

As described above, in the modification of the embodiments, the host computer 200 works also as the storage network management device 300 and, in addition, the storage network 400 works also as the management network 430. This configuration saves the hardware resources of the whole system and reduces the cost required to build the storage network.

### Second Modification of Embodiments

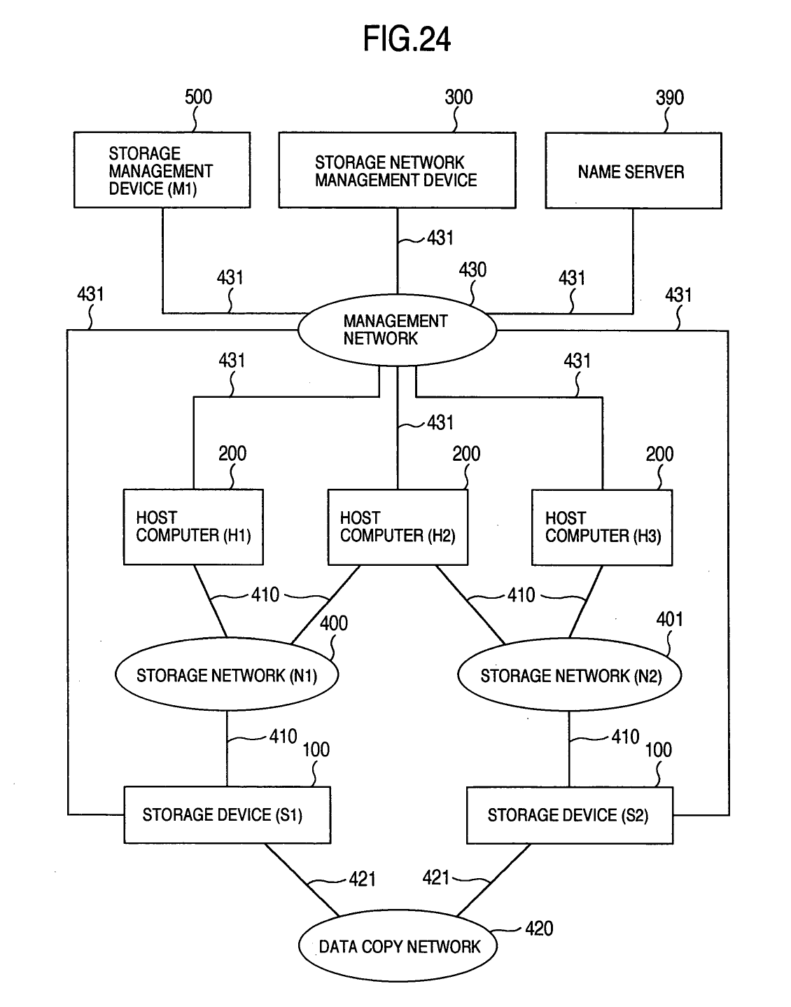

Another modification of the first or second embodiment is provided wherein a storage management device 500 is further provided in the first or second embodiment to manage storage devices 100. FIG. 24 is a diagram showing the configuration of a storage network system where the storage management device 500 is further provided in the storage network system in the first or second embodiment. The storage management device 500 is configured so that it can communicate with the storage network management device 300 and the storage device 100 via the management network 430.

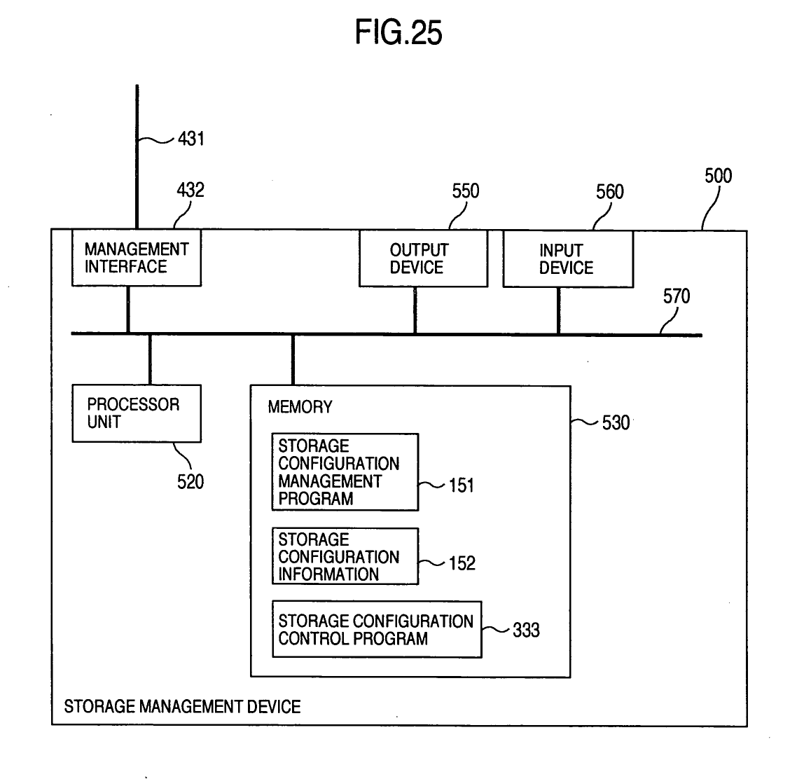

FIG. 25 is a diagram showing an example of the configuration of the storage management device in the modification of the embodiments. The hardware configuration of the storage management device 500 is the same as that of the storage network management device 300 in FIG. 6. The storage management device 500 in the modification of the embodiments comprises the storage configuration management program 151 and the storage configuration information 152 provided in the storage device 100 in the first or second embodiment and the storage configuration control program 333 provided in the storage network management device 300. The function and the processing procedure of the devices and the programs in the modification of the embodiments are the same as those of the devices and the programs in the first or second embodiment. In this modification, the storage management device 500 is responsible for the operation of the storage configuration management program 151, the storage configuration information 152, and the storage configuration control program 333 when they are brought into operation.

In the first embodiment, the system administrator must enter information on the source storage extent 111 and the destination storage extent 112 at the storage device 100 where the source storage extent 111 is included. In this modification of the embodiments, the storage management device 500 performs this entry work. That is, when the source storage extent 111 is on a plurality of storage devices 100, the system administrator must perform the entry work at the plurality of storage devices 100 in the first embodiment. In this modification of the embodiments, the storage management device 500 performs this entry work and thus reduces the entry workload on the system administrator.

It should be further understood by those skilled in the art that although the foregoing description has been made on embodiments of the invention, the invention is not limited thereto and various changes and modifications may be made without departing from the spirit of the invention and the scope of the appended claims.

1. A storage network migration method for use in a storage network system comprising at least one storage device, at least one host computer, a first storage network and a second storage network connecting said storage device and said host computer, a storage network management device, and a management network via which said storage network management device is connected to said storage device and said host computer, wherein a first data extent included in said storage device and connected to said first storage network is migrated to a second data extent included in said storage device and connected to said second storage network, said storage network migration method comprising:
a first step by said storage network management device which acquires information on a network interface of the storage network, connected to the storage device or the host computer, from the storage device and the host computer via the management network and stores the acquired information as network configuration information;
a second step, by the storage device including the first data extent, which receives information identifying the first data extent and the second data extent, adds and stores the received information in storage configuration information thereof, and sends the stored information and attribute information stored in the first data extent to said storage network management device;
a third step by said storage network management device which converts the attribute information stored in the first data extent to attribute information to be stored in the second data extent based on the storage network configuration information stored in said first step and the information sent from said storage device in said second step;
a fourth step by said storage network management device which sends the attribute information, converted in said third step, to the storage device including the second data extent; and
a fifth step, by the storage device including the second data extent, which adds and stores the attribute information sent from said storage network management device in said fourth step to storage configuration thereof as attribute information in the second data extent.

2. The storage network migration method according to claim 1, further comprising:
a sixth step, executed by said storage network management device between said third step and said fourth step, which receives the same attribute information as the attribute information in the second data extent and adds the received attribute information to the attribute information in the second data extent.

3. The storage network migration method according to claim 1,
wherein said storage network system includes a storage management device connected to said management network; and
wherein said storage management device executes said second step in place of the storage device including the first data extent.

4. The storage network migration method according to claim 1,
wherein said attribute information is set in a data extent and includes identification information on a host computer having access permission for the data extent.

5. The storage network migration method according to claim 1,
wherein a network protocol of the first storage network is different from a network protocol of the second storage network.

6. The storage network migration method according to claim 1,
wherein a network protocol of the first storage network is a network protocol based on Fibre Channel and a network protocol of the second storage network is a network protocol based on iSCSI (Internet Small Computer System Interface) and
wherein identification information on the host computer included in the attribute information stored in the first data extent is a WWPN (World Wide Port Number) and identification information on the host computer included in the attribute information stored in the second data extent is an iSCSI name.

7. The storage network migration method according to claim 1,
wherein a network protocol of the first storage network is a network protocol based on iSCSI and a network protocol of the second storage network is a network protocol based on Fibre Channel; and
wherein identification information on the host computer included in the attribute information stored in the first data extent is an iSCSI name and identification information on the host computer included in the attribute information stored in the second data extent is a WWPN.

8. A storage network management device for use in a storage network system comprising at least one storage device, at least one host computer, a first storage network and a second storage network connecting said storage device and said host computer, a storage network management device, and a management network via which said storage network management device is connected to said storage device and said host computer, wherein said storage network management device manages a data extent migration in which a first data extent included in said storage device and connected to said first storage network is migrated to a second data extent included in said storage device and connected to said second storage network, said storage network management device comprising:
a processor unit;
a management interface connected to said management network via a management network path;
an input device;
an output device; and
a communication bus interconnecting said processor unit, said management interface, said input device, and said output device,
wherein said processor unit acquires information on a network interface of the storage network, connected to the storage device or the host computer, from the storage device and the host computer via the management network and stores the acquired information as storage network configuration information;
wherein said processor unit receives identification information on the first data extent, identification information on the second data extent, and attribute information set in the first data extent sent from the storage device including the first data extent;
wherein said processor unit converts the attribute information set in the first data extent to attribute information to be stored in the second data extent, based on the stored storage network configuration information, the received identification information on the first data extent, and the identification information on the second data extent; and
wherein said processor unit sends the converted attribute information to the storage device including the second data extent.

9. The storage network management device according to claim 8,
wherein, before converting the attribute information set in the first data extent to the attribute information to be stored in the second data extent, said processor unit receives the same attribute information as the attribute information in the second data extent and adds the received attribute information to the attribute information in the second data extent.

10. The storage network management device according to claim 8,
wherein said attribute information is set in a data extent and includes identification information on a host computer having access permission for the data extent.

11. The storage network management device according to claim 8,
wherein a network protocol of the first storage network is different from a network protocol of the second storage network.

12. The storage network management device according to claim 8,
wherein a network protocol of the first storage network is a network protocol based on Fibre Channel and a network protocol of the second storage network is a network protocol based on iSCSI; and
wherein identification information on the host computer included in the attribute information stored in the first data extent is a WWPN and identification information on the host computer included in the attribute information stored in the second data extent is an iSCSI name.

13. The storage network management device according to claim 8,
wherein a network protocol of the first storage network is a network protocol based on iSCSI and a network protocol of the second storage network is a network protocol based on Fibre Channel; and
wherein identification information on the host computer included in the attribute information stored in the first data extent is an iSCSI name and identification information on the host computer included in the attribute information stored in the second data extent is a WWPN.

14. A storage network management program for use in a storage network system comprising at least one storage device, at least one host computer, a first storage network and a second storage network connecting said storage device and said host computer, a storage network management device, and a management network via which said storage network management device is connected to said storage device and said host computer, wherein said storage network management program is stored in said storage network management device that manages a data migration in which a first data extent included in said storage device and connected to said first storage network is migrated to a second data extent included in said storage device and connected to said second storage network, said storage network management program causing said storage network management device to:
acquire information on a network interface of the storage network, connected to the storage device or the host computer, from the storage device and the host computer via the management network and store the acquired information as storage network configuration information;
receive identification information on the first data extent, identification information on the second data extent, and attribute information set in the first data extent sent from the storage device including the first data extent;
convert the attribute information stored in the first data extent to attribute information to be stored in the second data extent based on the stored storage network configuration information, the received identification information on the first data extent, and the identification information on the second data extent; and
send the converted attribute information to the storage device including the second data extent.

15. The storage network management program according to claim 14, said program further causing said storage network management device to receive the same attribute information as the attribute information in the second data extent before converting the attribute information set in the first data extent to attribute information to be stored in the second data extent, and add the received attribute information to the attribute information in the second data extent.

16. The storage network management program according to claim 14,
wherein said attribute information is set in a data extent and includes identification information on a host computer having access permission for the data extent.

17. The storage network management program according to claim 14,
wherein a network protocol of the first storage network is different from a network protocol of the second storage network.

18. The storage network management program according to claim 14,
wherein a network protocol of the first storage network is a network protocol based on Fibre Channel and a network protocol of the second storage network is a network protocol based on iSCSI; and
wherein identification information on the host computer included in the attribute information stored in the first data extent is a WWPN and identification information on the host computer included in the attribute information stored in the second data extent is an iSCSI name.

19. The storage network management program according to claim 14,
wherein a network protocol of the first storage network is a network protocol based on iSCSI and a network protocol of the second storage network is a network protocol based on Fibre Channel; and
wherein identification information on the host computer included in the attribute information stored in the first data extent is an iSCSI name and identification information on the host computer included in the attribute information stored in the second data extent is a WWPN.

20. A storage network system comprising:
a first storage device including a first data extent;
a second storage device including a second data extent;
a first host computer which accesses the first data extent;
a second host computer which accesses the first and second data extents;
a third host computer which accesses the second data extent;
a first storage network to which said first storage device and said first and second host computers are connected;
a second storage network to which said second storage device and said second and third host computers are connected;
a data copy network to which said first and second storage devices are connected;
a storage network management device which acquires information on network interfaces of said first and second storage networks, to which said first and second storage devices and said first, second, and third host computers are connected, from said first and second storage devices and said first, second, and third host computers for managing a data extent migration;
a storage management device which acquires configuration information on said first and second storage devices from said first and second storage devices, receives identification information on the first and second data extents and attribute information to be set in the first data extent, and sends the acquired and received information to said storage network management device;
a name server which resolves an iSCSI name; and
a management network to which said first and second storage devices, said first, second, and third host computers, said storage management device, said storage network management device, and said name server are connected.
